(19) United States
(12) Patent Application Publication
(10) Pub. No.: US 2007/0134603 A9
(43) Pub. Date: Jun. 14, 2007

(54) Photothermographic material

(76) Inventors: Yasuhiro Yoshioka, Kanagawa (JP); Toyohisa Oya, Kanagawa (JP)

Correspondence Address: TAIYO CORPORATION, 401 HOLLAND LANE, #407, ALEXANDRIA, VA, 22314, US

(21) Appl. No.: 10/622,668

(22) Filed: Jul. 21, 2003

Related U.S. Application Data
(63) Continuation-in-part of application No. 09/695,864, filed on Oct. 26, 2000, now Pat. No. 6,696,237.

(30) Foreign Application Priority Data
Jul. 23, 2002 (JP) 2002-214209

(51) Int. Cl. G03C 1/498

(52) U.S. Cl. 430/619; 430/264; 430/351; 430/607; 430/611; 430/965

(57) ABSTRACT

The present invention provides a photothermographic material comprising a substrate, and a photosensitive silver halide, a non-photosensitive organic silver salt, reducing agents for thermal development and a binder which are provided on the substrate, wherein: the reducing agents for thermal development include a reducing agent which does not form a dye during thermal development and a reducing agent which forms a dye during thermal development; and the reducing agent which forms a dye has higher activity than that of the reducing agent which does not form a dye. It is preferable that the reducing agent which forms a dye at thermal development and has a specific chemical structure is contained in an amount of 40% by mol or less relative to a total amount of the reducing agents.

### CROSS-REFERENCE TO RELATED APPLICATIONS

This application claims benefit of and priority to Japanese Patent Application No. 2002-214209, filed on Jul. 23, 2002, which is incorporated herein by reference in its entirety for all purposes.

### BACKGROUND OF THE INVENTION

1. Field of Invention

The present invention relates to a photothermographic material, in particular, an improved photothermographic material which has a reduced change in color tone relative to condition changes in a thermal developing temperature and a thermal developing time, and provides stable finishing.

2. Description of the Related Art

Recently, in the medical field, decrease in an amount of a treated waste solution is strongly desired from the viewpoint of environment protection and space savings. Then, technologies regarding a photosensitive thermal developing photographic materials for medical diagnosis and photographic technology which can effectively expose to the light with a laser imagesetter or a laser imager and can form a clear black image having the high resolution and the sharpness are required. In these photosensitive thermal developing photographic materials, thermal developing treating system which can supply to customers more simple and does not deteriorate the environment by excluding the uses of solutions of treatment chemicals.

Similar requests also arise in the field of general image forming materials. However, since fine delineation is required for medical images, high image quality, which is excellent in the sharpness and granularity, is specifically required in images for medical applications. Moreover, cold black tone images are preferred in the images for medical applications from the viewpoint of easy diagnosis. Various hard copy systems utilizing a pigment and a dye, such as an ink-jet printer and electrophotography, are currently distributed as a general image forming system. However, there is no system which is satisfactory as an output system for images for medical applications.

In contrast to the above, a thermal image forming system utilizing an organic silver salt is described, for example, in U.S. Pat. Nos. 3,152,904 and 3,457,075, and “Thermally Processed Silver Systems” by B. Shely, Neblette, in Imaging Processes and Materials, 8^{th} edition, edited by Sturge, V. Walworth, A. Shepp, page 2, 1996. In particular, a photothermographic material generally has a photosensitive layer in which an catalytically-active amount of a photocatalyst (e.g. a silver halide), a reducing agent, a reducible silver salt (e.g. an organic silver salt) and, if necessary, a color tone agent for controlling color tone of silver, are dispersed in a matrix of a binder. Such a photothermographic material is heated to a high temperature (e.g. 80° C. or higher) after image exposure, and forms a black silver image by a redox reaction between silver halide or reducible silver salt (functioning as an oxidizing agent) and a reducing agent. A redox reaction is promoted by a catalytic action of a latent image of silver halide generated by the exposure. Therefore, a black silver image is formed on an exposed portion. Such thermal image forming systems utilizing organic silver salts are described in many publications including U.S. Pat. No. 2,910,377 and Japanese Patent Application Publication (JP-B) No. 43-4924 as medical image forming systems utilizing photothermographic materials, and, Fuji Medical Dry Imager FM-DP L (trade name, manufactured by Fuji Film Medical System Co., Ltd.) is sold as a thermal image forming systems for medical application.

As methods for preparing a thermal image forming system utilizing an organic silver salt, a process by solvent coating, and a process by coating a coating solution containing a polymer fine particle as a main binder dispersed in water and drying thereof are known. Since a step of recovering a solvent is not necessary in the latter process, the preparation facilities are simple, thus the latter process is advantageous for large scale production.

In the photothermographic material, an image is formed of a developed silver grain generated by a thermal development. It is known that color tone of developed silver is changed by the form and the surface state thereof. In the diagnostic image in the medical field, there is a tendency that cold black tone, namely, a bluish silver image is preferred due to its high diagnosis ability, and control of silver tone has been variously studied. For example, Japanese Patent Application Laid-Open (JP-A) No. 2000-241927 describes a method of controlling silver tone by adjusting the contained amounts of ammonium ions and sodium ions in a photosensitive material. This method enables controlling color tone to an extent, however, there is a limit in controling color tone freely because when one tries to increase a ratio of sodium ions to obtain yellowish color, cyanish yellow is decreased at the same. In addition, since photographic properties such as the sensitivity, the maximum concentration and the like are influenced at the same time, and thus a practical application range of the method is limited.

Further, a method of controlling color tone of an image by selecting a kind of a reducing agent is described in JP-A No. 2001-188314. Furthermore, a method of controlling color tone of an image by additionally using a hindered phenol compound is described in JP-A No. 2002-169249. When these methods are utilized, image color tone can be assuredly controlled to preferable color tone and, when the aforementioned adjustment with sodium ions and ammonium ions is further combined thereto, a control range is considerably widened, and thus, it can be said that this is the practical high value technique.

However, although color tone adjusted by these methods provides desired preferable color tone under the certain developing conditions, a problem was found that when the developing conditions vary, namely, when a developing temperature and a developing time vary, color tone is changed, and becomes outside a preferable range. Although a developing temperature and a developing time are controlled by a thermal developing machine, variation and scatter to an extent can not be prevented, and there is a high possibility that these cause scatters in finished color tone in the market. Additionally, severe spec is also required to a thermal developing machine, and thus, there is a problem that the cost load becomes great.

### SUMMARY OF THE INVENTION

Accordingly, the first object of the present invention is to provide a method of stably controlling color tone of a finished image of a photothermographic material. The second object of the invention is to provide a photothermographic material by which image color tone is hardly changed by variation of a thermal developing temperature and a thermal developing time and stable finishing usually becomes possible.

The invention provides a photothermographic material comprising a substrate, and a photosensitive silver halide, a non-photosensitive organic silver salt, reducing agents for thermal development and a binder which are provided on the substrate, wherein:
the reducing agents for thermal development include a reducing agent which does not form a dye during thermal development and a reducing agent which forms a dye during thermal development; and
the reducing agent which forms a dye has higher activity than that of the reducing agent which does not form a dye.

One aspect of the present invention is to provide the photothermographic material, wherein the reducing agent which does not form a dye is a compound represented by the general formula (R1), and the reducing agent which forms a dye is a compound represented by the following general formula (R2): 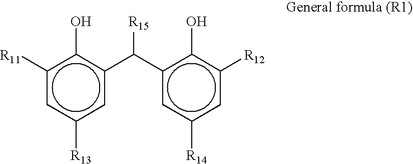
wherein R₁₁ and R₁₂ each independently represent a secondary or tertiary alkyl group; R₁₃ and R₁₄ each independently represent an alkyl group having a 2 or more carbon atoms; and R₁₅ represents an alkyl group: 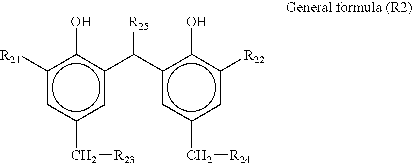
wherein R₂₁ and R₂₂ each independently represent a secondary or tertiary alkyl group; R₂₃ and R₂₄ each independently represent a hydrogen atom, a hydroxyl group, an alkoxy group, an aryloxy group, an acyloxy group, an amino group or a heterocyclic group; and R₂₅ represents a hydrogen atom or an alkyl group.

### DETAILED DESCRIPTION OF THE INVENITON

The present invention will be explained in detail below.

Reducing Agent

The present inventors intensively studied in order to attain the object of the invention. As a result, we found that a reducing agent represented by the following general formula (R1) does not give a coloring component in a photosensitive material, while a compound represented by the following general formula (R2) produces a dye product which is yellow-colored. And, we have found that by using a combination of the reducing agent of the general formula (R1) and the reducing agent of the general formula (R2), it is possible to control image color tone. In addition, we found that by using a combination by selecting a reducing agent of the general formula (R2) having the higher activity than that of a reducing agent of the general formula (R1) having the lower activity, variation in color tone relative to a developing temperature and a developing time can be remarkably decreased.

Further, it has been also found that the thus formed image has the surprising effect that change in color tone relative to the light and the heat is remarkably decreased with time. Reducing agent represented by the general formula (R1)

First, the reducing agent represented by general formula (R1) in the invention will be explained in detail.

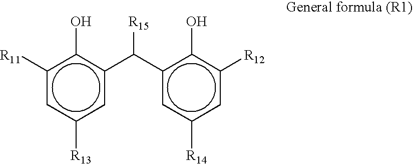

In the general formula (R1), R₁₁ and R₁₂ each independently represent a secondary or tertiary alkyl group, R₁₃ and R₁₄ each independently represent an alkyl group having a 2 or more carbon atoms, and R₁₅ represents an alkyl group.

R₁₁ and R₁₂ are preferably a secondary or tertiary alkyl group having 3 to 20 carbon atoms, and may have substituents. The substituents of the alkyl group is not particularly limited, but preferable examples include an aryl group, a hydroxyl group, an alkoxy group, an aryloxy group, an alkylthio group, an arylthio group, an acylamino group, a sulfoneamido group, sulfonyl group, a phosphoryl group, an acyl group, a carbamoyl group, an ester group, an ureido group, an urethane group, a halogen atom and the like.

R₁₃ and R₁₄ are preferably an alkyl group having 2 to 20 carbon atoms, and may have substituents which are same as those of R₁₁.

R₁₅ is preferably an alkyl group having 1 to 20 carbon atoms, and may have substituents which are same as those of R₁₁.

R₁₁ and R₁₂ are more preferably a secondary or tertiary alkyl group having 3 to 15 carbon atoms, and specific examples thereof include an isopropyl group, an isobutyl group, a t-butyl group, a t-amyl group, a t-octyl group, a cyclohexyl group, a cyclopentyl group, a 1-methylcyclohexyl group, and a 1-methylcyclopropyl group. R₁₁ and R₁₂ are further preferably a tertiary alkyl group having 4 to 12 carbon atoms and, inter alia, a t-butyl group, a t-amyl group, and a 1-methylcyclohexyl group are more preferably, and a t-butyl group is most preferable.

R₁₃ and R₁₄ are more preferably an alkyl group having 2 to 15 carbon atoms, and specific examples thereof include an ethyl group, a propyl group, a butyl group, an isopropyl group, an isobutyl group, a sec-butyl group, a t-butyl group, a t-amyl group, a cyclohexyl group, a 1-methylcyclohexyl group, a cyclohexylmethyl group, a benzyl group, a methoxyethyl group, a methoxybutyl group, and a N,N-dimethylaminoethyl group. More preferable are an ethyl group, a propyl group, a butyl group, an isopropyl group and a t-butyl group. Particularly preferable are an ethyl group and a propyl group, and an ethyl group is most preferable.

R₁₅ is more preferably an alkyl group having 1 to 15 carbon atoms, and examples thereof include a methyl group, an ethyl group, a propyl group, a butyl group, a heptyl group, an undecyl group, an isopropyl group, a 1-ethylpentyl group, a 2,4,4-trimethylpentyl group, a methoxymethyl group, a methoxypropyl group, a butoxyethyl group, a 2-acethylaminoethyl group, a 2-phenylthioethyl group and a 2-dodecylthioethyl group. More preferable examples include an alkyl group having 1 to 5 carbon atoms, such as a methyl group, an ethyl group, a propyl group, a butyl group, an isopropyl group and an isobutyl group and, among them, a methyl group, an ethyl group and a propyl group are preferable, and a methyl group is most preferable.

The compound represented by the general formula (R1) in the invention is a compound which does not form a yellow dye at thermal developing. Specific examples of a reducing agent in the invention represented by the general formula (R1) will be exemplified below, but the invention is not limited by them.

| | R₁₁ | R₁₂ | R₁₃ | R₁₄ | R₁₅ |
|---|---|---|---|---|---|
| R1-1 | t-C₄H₉ | t-C₄H₅ | C₂H₅ | C₂H₆ | CH₃ |
| R1-2 | t-C₄H₉ | t-C₄H₉ | C₂H₅ | C₂H₅ | C₂H₅ |
| R1-3 | t-C₄H₉ | t-C₄H₉ | C₂H₅ | C₂H₅ | n-C₃H₇ |
| R1-4 | t-C₄H₉ | t-C₄H₉ | C₂H₅ | C₂H₅ | n-C₅H₁₁ |
| R1-5 | t-C₄H₉ | t-C₄H₉ | C₂H₅ | C₂H₅ | i-C₃H₇ |
| R1-6 | t-C₄H₉ | t-C₄H₉ | n-C₃H₇ | n-C₃H₇ | CH₃ |
| R1-7 | t-C₄H₉ | t-C₄H₉ | n-C₃H₇ | n-C₃H₇ | n-C₃H₇ |
| R1-8 | t-C₄H₉ | t-C₄H₉ | n-C₄H₉ | n-C₄H₉ | CH₃ |
| R1-9 | t-C₄H₉ | t-C₄H₉ | CH₂C₆H₅ | CH₂C₆H₅ | CH₃ |
| R1- | t-C₄H₉ | t-C₄H₉ | CH₂C₆H₅ | CH₂C₆H₅ | n-C₃H₇ |
| 10 | | | | | |
| R1- | t-C₄H₉ | t-C₄H₉ | CH₂CH(CH₃)₂ | CH₂CH(CH₃)₂ | CH₃ |
| 11 | | | | | |
| R1- | t-C₄H₉ | t-C₄H₉ | i-C₃H₇ | i-C₃H₇ | CH₃ |
| 12 | | | | | |
| R1- | i-C₃H₇ | i-C₃H₇ | C₂H₅ | C₂H₅ | CH₃ |
| 13 | | | | | |
| R1- | i-C₃H₇ | i-C₃H₇ | i-C₃H₇ | i-C₃H₇ | CH₃ |
| 14 | | | | | |
| R1- | t-C₅H₁₁ | t-C₅H₁₁ | C₂H₅ | C₂H₅ | C₂H₅ |
| 15 | | | | | |
| R1- | t-C₄H₉ | t-C₄H₉ | C₂H₅ | C₂H₅ | C₂H₄OCH₃ |
| 16 | | | | | |

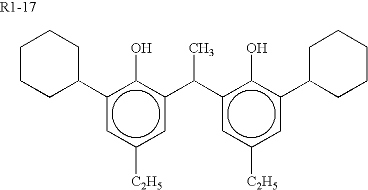

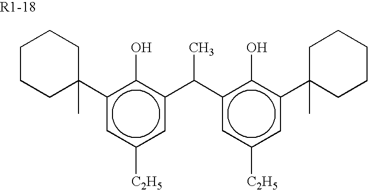

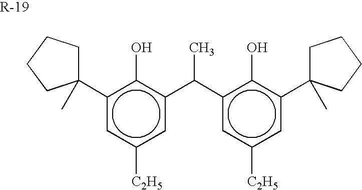

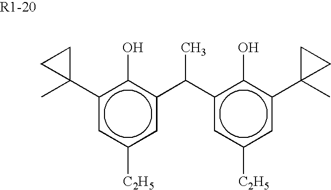

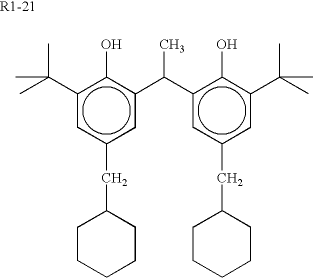

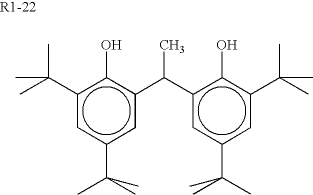

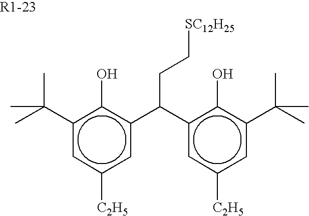

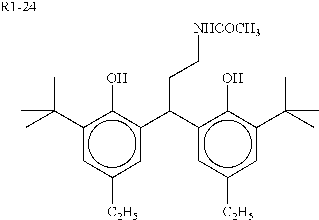

Reducing Agent Represented by General Formula (R2)

Then, the reducing agent represented by general formula (R2) in the invention will be explained in detail.

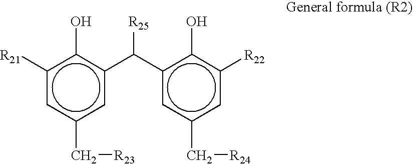

In the general formula (R2), R₂₁ and R₂₂ each independently represent a secondary or tertiary alkyl group, R₂₃ and R₂₄ each independently represent a hydrogen atom, a hydroxyl group, an alkoxy group, an aryloxy group, an acyloxy group, an amino group or a heterocyclic group, and R₂₅ represents a hydrogen atom or an alkyl group.

R₂₁ and R₂₂ are preferably a secondary or tertiary alkyl group having 3 to 20 carbon atoms, and may have substituents. The substituents of the alkyl group are not particularly limited, but preferable examples include an aryl group, a hydroxyl group, an alkoxy group, an aryloxy group, an alkylthio group, an arylthio group, an acylamino group, a sulfonamido group, a sulfonyl group, a phosphoryl group, an acyl group, a carbamoyl group, an ester group, an ureido group, an urethane group, and a halogen atom.

R₂₃ and R₂₄ are preferably a hydrogen atom, an alkyl group having 2 to 20 carbon atoms, an alkoxy group having 1 to 20 carbon atoms, an aryloxy group having 6 to 20 carbon atoms, an alkylamino group having 2 to 20 carbon atoms, an anilino group having 6 to 20 carbon atoms, an alkylthio group having 1 to 20 carbon atoms, an arylthio group having 6 to 20 carbon atoms, an acyloxy group having 1 to 20 carbon atoms or a heterocyclic group having 3 to 20 carbon atoms, and may have substituents which are same as those of R₂₁.

R₂₅ is preferably a hydrogen atom or an alkyl group having 1 to 20 carbon atoms, and may have substituents which are same as those of R₂₁.

R₂₁ and R₂₂ are more preferably a secondary or tertiary alkyl group having 3 to 15 carbon atoms, and examples thereof include an isopropyl group, an isobutyl group, a t-butyl group, a t-amyl group, a t-octyl group, a cyclohexyl group, a cyclopentyl group, a 1-methylcyclohexyl group, and 1-methylcyclopropyl group. R₂₁ and R₂₂ are further preferably a tertiary alkyl group having 4 to 12 carbon atoms, inter alia, a t-butyl group, a t-amyl group, and a 1-methylcyclohexyl group are more preferable, and a t-butyl group is most preferable.

R₂₃ and R₂₄ are more preferably a hydrogen atom, an alkyl group having 1 to 15 carbon atoms, a hydroxyl group, an alkoxy group, an aryloxy group or an amino group, and specific examples thereof include a hydrogen atom, a hydroxyl group, a methoxy group, an ethoxy group, a butoxy group, an octyloxy group, a methoxyethoxy group, a cyclohexyloxy group, a phenoxy group, a N,N-dimethylamino group, a N,N-dibutylamino group, a N-methylanilino group, and a piperidinyl group. More preferable are a hydrogen atom, a methoxy group, a N,N-dimethylamino group, and a hydrogen atom is most preferable.

R₂₅ is more preferably a hydrogen atom or an alkyl group having 1 to 15 carbon atoms, and specific examples thereof include a hydrogen atom, a methyl group, an ethyl group, a propyl group, a butyl group, a heptyl group, an undecyl group, an isopropyl group, a 1-ethylpentyl group, a 2,4,4-trimethylpenthyl group, a methoxymethyl group, a methoxypropyl group, a butoxyethyl group, a 2-acetylaminoethyl group, a 2-phenylthioethyl group, and a 2-dodecylthioethyl group. More preferable are a hydrogen atom and an alkyl group having 1 to 5 carbon atoms, and examples thereof include a hydrogen atom, a methyl group, an ethyl group, a propyl group, a butyl group, an isopropyl group, and an isobutyl group and, inter alia, a hydrogen atom, a methyl group, an ethyl group and a propyl group are preferable, and a hydrogen atom and a methyl group are most preferable.

The compound represented by the general formula (R2) in the invention is a compound which forms a yellow dye at thermal developing although they have a small difference in structures. Specific examples of a reducing agent in the invention represented by the general formula (R2) will be shown in below, but the invention is not limited by them.

| | R₂₁ | R₂₂ | R₂₃ | R₂₄ | R₂₅ |
|---|---|---|---|---|---|
| R2-1 | t-C₄H₉ | t-C₄H₉ | H | H | H |
| R2-2 | t-C₄H₉ | t-C₄H₉ | H | H | CH₃ |
| R2-3 | t-C₄H₉ | t-C₄H₉ | H | H | C₂H₅ |
| R2-4 | t-C₄H₉ | t-C₄H₉ | H | H | n-C₃H₇ |
| R2-5 | t-C₄H₉ | t-C₄H₉ | H | H | i-C₃H₇ |
| R2-6 | t-C₄H₉ | t-C₄H₉ | OH | OH | H |
| R2-7 | t-C₄H₉ | t-C₄H₉ | OH | OH | C₂H₅ |
| R2-8 | t-C₄H₉ | t-C₄H₉ | OCH₃ | OCH₃ | H |
| R2-9 | t-C₄H₉ | t-C₄H₉ | OCH₃ | OCH₃ | n-C₃H₇ |
| R2- | t-C₄H₉ | t-C₄H₉ | OCH₂C₆H₅ | OCH₂C₆H₅ | CH₃ |
| 10 | | | | | |
| R2- | t-C₄H₉ | t-C₄H₉ | OC₆H₁₃ | OC₆H₁₃ | H |
| 11 | | | | | |
| R2- | t-C₄H₉ | t-C₄H₉ | CH₂CH(CH₃)₂ | CH₂CH(CH₃)₂ | CH₃ |
| 12 | | | | | |
| R2- | t-C₄H₉ | t-C₄H₉ | N(CH₃)₂ | N(CH₃)₂ | CH₃ |
| 13 | | | | | |
| R2- | i-C₃H₇ | i-C₃H₇ | SC₁₂H₂₅ | SC₁₂H₂₅ | H |
| 14 | | | | | |
| R2- | t-C₅H₁₁ | t-C₅H₁₁ | OCOCH₃ | OCOCH₃ | C₂H₅ |
| 15 | | | | | |
| R2- | t-C₄H₉ | t-C₄H₉ | H | H | C₂H₄OCH₃ |
| 16 | | | | | |

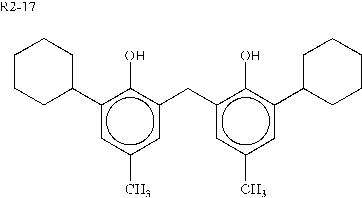

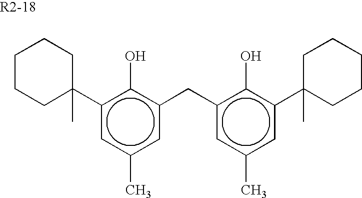

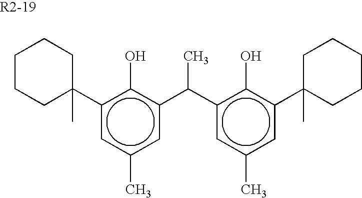

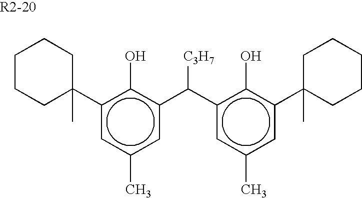

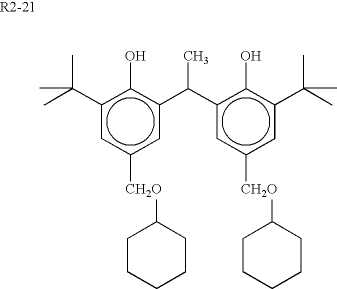

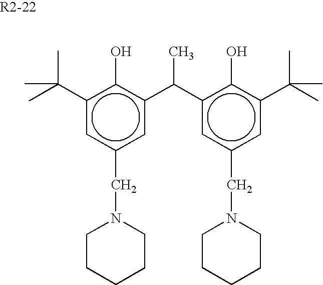

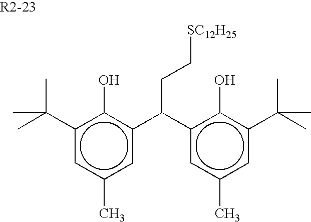

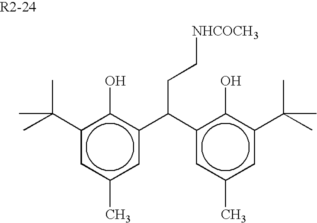

Examples of a preferable reducing agent in the invention other than the aforementioned ones are compounds which correspond to definition in the invention among compounds described in JP-A Nos. 2001-188314, 2001-209145, 2001-350235, and 2002-156727.

In the invention, a total amount of reducing agents of the general formulae (R1) and (R2) to be added is preferably 0.1 to 3.0 g/m², more preferably 0.2 to 1.5 g/m², further preferably 0.3 to 1.0 g/m². The reducing agents are contained preferably at 5 to 50% by mol, more preferably 8 to 30% by mol, further preferably 10 to 20% by mol relative to 1 mole of silver on the surface having an image forming layer. It is preferable that reducing agents are contained in an image forming layer.

It is preferable that the reducing agent (R1) of the invention is used at a larger molar amount relative to the reducing agent (R2) in the invention. Preferably, the reducing agent (R2) is contained in an amount of 40% by mol or less, more preferably in a range of 5 to 40% by mol, further preferably in a range of 10 to 30% by mol relative to a total molar amount of the reducing agents.

The relative relationship between the developing activities of reducing agents in the invention can be evaluated from the relative relationship between sensitivities when the reducing agent in the invention is used alone, in such the construction that the reducing agent in the invention is tried to be used. In the invention, when the reducing agent A represented by the general formula (R2) has a higher logarithmic value (−LogE) of an exposing amount E giving the concentration 1.5 than that of the reducing agent B represented by the general formula (R1) by 0.02 or larger, it can be judged that the reducing agent A has the higher developing activity than that of the reducing agent B. In the invention, the reducing agent of the general formula (R2) has a higher relative value of sensitivity than that of the reducing agent of the general formula (R1) preferably by 0.03 or larger, more preferably 0.05 or larger, further preferably 0.08 or larger. A difference in relative sensitivities grows larger, a ratio of the compound of the general formula (R2) to be used may be smaller. When a difference in relative sensitivities is 0.05 or larger, a ratio of the reducing agent of the general formula (R2) is preferably 30% by mol or smaller, while when a difference in relative sensitivities is 0.10 or larger, a ratio of the reducing agent of the general formula (R2) is preferably 20% by mol or smaller.

The reducing agent in the invention may be contained in a coating solution, or may be contained in a photosensitive material in any method such as the solution form, the emulsified dispersion form, and the solid fine particle dispersion form.

As the well known emulsifying and dispersing method, there is a method of mechanically preparing an emulsified dispersion by dissolving using an oil such as dibutyl phthalate, tricresyl phosphate, glyceryl acetate and diethyl phthalate, or an assistant solvent such as ethyl acetate and cyclohexanone.

In addition, examples of a method of dispersing a solid fine particle include a method of dispersing a powder of a reducing agent in an appropriate solvent such as water and the like by a ball mill, a colloid mill, a vibration ball mill, a sand mill, a jet mill, a roller mill or an ultrasound, to make a solid dispersion. Upon this, a protective colloid (e.g. polyvinyl alcohol), and a surfactant (e.g. anionic surfactant such as sodium triisopropylnaphthalenesulfonate (mixture of compounds having different substitutable places for three isopropyl groups)) may be used. In the aforementioned mills, beads of zirconia and the like are usually used as a dispersion medium, and Zr or the like eluted from these beads may be mixed in a dispersion in some cases. Dispersion is performed usually in a range of 1 ppm to 1000 ppm depending on the dispersing conditions. The content of Zr in a photosensitive material is practically sufficient as far as it is 0.5 mg or smaller per 1 g of silver.

It is preferable that, a preservative (e.g. benzoisothiazolinone sodium salt) is contained in a water dispersion.

In the invention, it is preferable that a reducing agent is used as a solid dispersion.

In the invention, in addition to the aforementioned two kinds of reducing agents, the previously known reducing agent for an organic silver salt may be used jointly. Examples of these reducing agents are described in JP-A No. 11-65021, paragraph numbers 0043 to 0045, and EP Laid-Open No. 803764A1, page 7, line 34 to page 18, line 12. It is particularly preferable that a hindered phenol type reducing agent having a substituent at an ortho position of a phenolic hydroxyl group, or a bisphenol type reducing agent is used jointly. Explanation of organic silver salt

1) Composition

An organic silver salt which can be used in the invention is a silver salt which is relatively stable to the light, but functions as a silver ion donor when heated to 80° C. or higher in the presence of exposed photosensitive silver halide and a reducing agent, and, whereby, a silver image is formed. An organic silver salt may be an arbitrary organic substance which can supply a silver ion reducible by a reducing agent. Such the non-photosensitive organic silver salt is described in JP-A No. 10-62899, paragraph numbers 0048 to 0049, EP Laid-Open No. 0803764A1, page 18, line 24 to page 19, line 37, EP Laid-Open No. 0962812A1, JP-A Nos. 11-349591, 2000-7683, 2000-72711 and the like. A silver salt of an organic acid, in particular, a silver salt of a long chain aliphatic carboxylic acid (having 10 to 30 carbon atoms, preferable 15 to 28 carbon atoms) is preferable. Preferable examples of a fatty acid silver salt include silver lignocerate, silver behenate, silver arachidate, silver stearate, silver oleate, silver laurate, silver caproate, silver myristate, silver palmitate, silver erucate and a mixture thereof. In the invention, among these fatty acid silvers, it is preferable to use fatty acid silver having the silver behenate content of, preferably not less than 50% by mol and not more than 100% by mol, more preferably not less than 85% by mol and not more than 100% by mol, further preferably not less than 95% by mol and not more than 100% by mol. Further, it is preferable to use fatty acid silver having the erucic acid content of not more than 2% by mol, more preferably not more than 1% by mol, further preferably not more than 0.1% by mol.

In addition, it is preferable that the silver stearate content is not more than 1% by mol. When the stearic acid content is not more than 1% by mol, a silver salt of an organic acid having low Dmin and the high sensitivity and excellent in the image shelf stability is obtained. The stearic acid content is preferably not more than 0.5% by mol, particularly preferably substantially zero.

Further, when silver arachidate is contained as a silver salt of an organic acid, the silver arachidate content is preferably not more than 6% by mol in that low Dmin is obtained and a silver salt of an organic acid excellent in the image shelf stability is obtained, further preferably not more than 3% by mol.

2) Shape

A shape of an organic silver salt which can be used in the invention is not particularly limited, but either of needle-like, bar-like, plate-like or scale-like may be used.

In the invention, a scale-like organic silver salt is preferable. In addition, short needle-like, rectangular parallelepiped, cubic or potato-like indefinite-shaped particle having a ratio of a length of a long axis and that of a short axis of 5 or smaller is also preferably used. These organic silver particles have the characteristic that fog is small at thermal developing as compared with a long needle-like particle having a ratio of a length of a long axis and that of a short axis of 5 or larger. In particular, a particle having a ratio of a long axis and a short axis of 3 or smaller is preferable since the mechanical stability of a coated film is improved. In the invention, a scale-like organic silver salt is defined as follows: An organic acid silver salt is observed with a microscope, a shape of an organic acid silver salt particle is approximated as a rectangular parallelepiped and, letting sides of this rectangular parallelepiped to be a, b and c from shortest (c may be the same as b), shorter numerical values a and b are used for calculation, and x is obtained as follows:
x=b/a

Like this, regarding around 200 particles, x is obtained and, letting an average to be x (average), a particle satisfying the relationship x (average)≧1.5 is regarded as scale-like. Preferably 30≧x (average)≧1.5, more preferably 15≧x (average)≧1.5. Incidentally, needle-like is 1≦x(average)<1.5.

In a scale-like particle, a can be regarded as a thickness of a plate-like particle having a plane in which b and c are sides as a main plane. An average of a is preferably not less than 0.01μ and not more than 0.3 μm, more preferably not less than 0.1 μm and not more than 0.23 μm. An average of c/b is preferably not less than 1 and not more than 9, more preferably not less than 1 and not more than 6, further preferably not less than 1 and not more than 4, most preferably not less than 1 and not more than 3.

When the aforementioned sphere-equivalent diameter is not less than 0.05 μm and not more than 1 μm, aggregation hardly occurs in a photosensitive material, and the image shelf stability becomes better. The sphere-equivalent diameter is preferably not less than 0.1 μm and not more than 1 μm. In the invention, a sphere-equivalent diameter is obtained by imaging a sample directly using an electron microscope and, thereafter, subjecting a negative to image treatment.

In the scale-like particle, sphere-equivalent diameter/a of a particle is defined as an aspect ratio. An aspect ratio of a scale-like particle is preferably not less than 1.1 and not more than 30, more preferably not less than 1.1 and not more than 15 from the viewpoint that aggregation hardly occurs in a photosensitive material, and the image shelf stability becomes better.

It is preferable that a size dispersion of an organic silver salt particle is monodisperse. Monodisperse is such that a percentage of a standard deviation of a length of each of a short axis and a long axis divided by a short axis or a long axis is preferably not more than 100%, more preferably not more than 80%, further preferably not more than 50%. A shape of an organic silver salt can be obtained by a transmission electron microscope image of an organic silver salt dispersion. As another method of measuring monodispersity, there is a method of obtaining a standard deviation of a volume-weighed average diameter of an organic silver salt, and a percentage of a value divided by a volume-weighed average diameter (variation coefficient) is preferably not more than 100%, more preferably not more than 80%, further preferably not more than 50%. As a measuring method, for example, an organic silver salt dispersed in a liquid is irradiated with the laser light, a self correlation function relative to a time change of fluctuation of the scattered light is obtained, and monodispersity can be obtained from the obtained particle size (volume-weighed average diameter).

3) Preparation

As a process for preparing an organic acid silver used in the invention and a method of dispersing it, the known methods can be applied. For example, see the aforementioned JP-A No. 10-62899, EP Laid-Open Nos. 0803763A1, 0962812A1, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870, 2002-107868 and the like.

When a photosensitive silver salt is present jointly at dispersing of an organic silver salt, since the fog is increased and the sensitivity is remarkably lowered, it is preferable that a photosensitive silver salt is not substantially contained at dispersing. In the invention, an amount of a photosensitive silver salt to be dispersed in a water dispersion is preferably not more than 1% by mol, more preferably not more than 0.1% by mol relative to 1 mol of an organic acid silver salt in the solution, further preferably a photosensitive silver salt is not added positively.

In the invention, a photosensitive material can be prepared by mixing an organic silver salt water dispersion and a photosensitive silver salt water dispersion, and a mixing ratio of an organic silver salt and a photosensitive silver salt can be selected depending on the purpose. A ratio of a photosensitive silver salt relative to an organic silver salt is preferably in a range of 1 to 30% by mol, further 2 to 20% by mol, particularly preferably in a range of 3 to 15% by mol. Mixing of two or more kinds of organic silver salt water dispersions and two or more kinds of photosensitive silver salt water dispersions is a method which is preferably used for regulating the photographic properties.

4) Addition Amount

An organic silver salt in the invention can be used at a desired amount, and a total coating silver amount including silver halide is preferably 0.1 to 5.0 g/m², more preferably 0.3 to 3.0 g/m², further preferably 0.5 to 2.0 g/m². In particular, in order to improve the image shelf stability, it is preferable that a total coating silver amount is not more than 1.9 g/m², more preferably not more than 1.8 g/m², further preferably not more than 1.6 g/m². When a preferable reducing agent in the invention is used, it is possible to obtain the sufficient image concentration at such the low silver amount.

Explanation of Development Promoter

In the photothermographic material of the invention, as a development promoter, sulfonamidophenol type compounds represented by the general formula (A) described in JP-A Nos. 2000-267222, 2000-330234 and the like, hindered phenol type compounds represented by the general formula (II) described in JP-A No. 2001-92075, hydrazine type compounds represented by the general formula (I) described in JP-A Nos. 10-62895, 11-15116 and the like, the general formula (D) described in JP-A No. 2002-156727, and the general formula (1) described in Japanese Patent Application No. 2001-074273, and phenol type or naphthol type compounds represented by the general formula (2) described in JP-A No. 2001-264929 are preferably used. These development promoters are used in a range of 0.1 to 20% by mol, preferably in a range of 0.5 to 10% by mol, more preferably in a range of 1 to 5% by mol relative to a reducing agent. As a method of introduction into a photosensitive material, there are the same methods as those for a reducing agent. In particular, it is preferable to add as a solid dispersion or an emulsion dispersion. When added as an emulsion dispersion, it is preferable to add as an emulsion dispersion obtained by dispersing using a high boiling point solvent which is solid at a normal temperature and a low boiling point assistant solvent, or add as a so-called oilless emulsion dispersion without using a high boiling point solvent.

In the invention, among the aforementioned development promoters, hydrazine type compounds represented by the general formula (D) described in JP-A No. 2002-156727, and phenol type or naphthol type compounds represented by the general formula (2) described in JP-A No. 2001-264929 are more preferable.

Particularly preferable development promoters in the invention are a compound represented by the following general formulae (A-1) and a compound represented by the following general formula (A-2).
Q₁-NHNH-Q₂ General formula (A-1)
wherein Q₁ represents an aromatic group or a heterocyclic group which bonds to —NHNH-Q₂ via a carbon atom; Q₂ represents a carbamoyl group, an acyl group, an alkoxycarbonyl group, an aryloxycarbonyl group, a sulfonyl group or a sulfamoyl group.

In the general formula (A-1), as an aromatic group or a heterocyclic group represented by Q₁, a 5 to 7-membered unsaturated ring is preferable. Preferable examples include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3,4-triazole ring, a 1,2,4-triazole ring, a tetrazole ring, a 1,3,4-thiadiazole ring, a 1,2,4-thiadiazole ring, a 1,2,5-thiadizole ring, a 1,3,4-oxadiazole ring, a 1,2,4-oxathiazole ring, a 1,2,5-oxathiazole ring, a thiazole ring, an oxazole ring, an isothiazole ring, an isoxazole ring, and a thiophene ring. Further, condensed rings in which these rings are mutually condensed are also preferable.

These rings may have a substituent and, when rings have two or more substituents, those substituents may be the same or different. Examples of a substituent include a halogen atom, an alkyl group, an aryl-group, a carbonamido group, an alkylsulfonamido group, an aryl sulfonamido group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group, and an acyl group. When these substituents are a substitutable group, they may have a further substituent, and examples of a preferable substituent include a halogen atom, an alkyl group, an aryl group, a carbonamido group, an alkylsulfonamido group, an arylsulfonamido group, an alkoxy group, an aryloxy group, an alkylthio group, an arylthio group, an acyl group, an alkoxycarbonyl group, an aryloxycarboxyl group, a carbamoyl group, a cyano group, a sulfamoyl group, an alkylsulfonyl group, an arylsulfonyl group, and an acyloxy group.

A carbamoyl group represented by Q₂ is a carbamoyl group having, preferably 1 to 50 carbon atoms, and more preferably 6 to 40 carbon atoms, and examples thereof include unsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl) carbamoyl, N-naphthylcarbamoyl, N-3-pyridylcarbamoyl, and N-benzylcarbamoyl.

An acyl group represented by Q₂ is an acyl group having, preferably 1 to 50 carbon atoms, and more preferably 6 to 40 carbon atoms, and examples thereof include formyl, acetyl, 2-methylpropanoyl, cyclohexylcarbonyl, octanoyl, 2-hexyldecanoyl, decanoyl, chroloacetyl, trifluoroacetyl, benzoyl, 4-dodecyloxybenzoyl, and 2-hydroxymethylbenzoyl. An alkoxycarbonyl group represented by Q₂ is an alkoxycarbonyl group having, preferably 2 to 50 carbon atoms, and more preferably 6 to 40 carbon atoms, and examples thereof include methoxycarbonyl, ethoxycarbonyl, isobutyloxycarbonyl, cyclohexyloxycarbonyl, dodecyloxycarbonyl, and benzyloxycarbonyl.

An aryloxycarbonyl group represented by Q₂ is an aryloxycarbonyl group having, preferably 7 to 50 carbon atoms, and more preferably 7 to 40 carbon atoms, and examples thereof include phenoxycarbonyl, 4-octyloxyphenoxycarbonyl, 2-hydroxymethylphenoxycarbonyl, and 4-dodecyloxyphenoxycarbonyl. A sulfonyl group represented by Q₂ is a sulfonyl group having, preferably 1 to 50 carbon atoms, and more preferably 6 to 40 carbon atoms, and examples thereof include methylsulfonyl, butylsulfonyl, octylsulfonyl, 2-hexadecylsulfonyl, 3-dodecyloxypropylsulfonyl, 2-octyloxy-5-tert-octylphenylsulfonyl, and 4-dodecyloxyphenylsulfonyl.

A sulfamoyl group represented by Q₂ is a sulfamoyl group having, preferably 0 to 50 carbon atoms, and more preferably 6 to 40 carbon atoms, and examples thereof include unsubstituted sulfamoyl, N-ethylsulfamoyl, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbomylphenyl)sulfamoyl, and N-(2-tetradecyloxyphenyl)sulfamoyl. A group represented by Q₂ may have further a group exemplified as an example of a substituent of a 5 to 7-membered unsaturated ring represented by Q₁ at a substitutable position and, when a group have two or more substituents, those substituents may be the same or different.

Then, a preferable range of compounds represented by the formula (A-1) will be described. As Q₁, a 5 to 6-membered unsaturated ring is preferable, and a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isoxazole, and rings in which these rings are condensed with a benzene ring or an unsaturated heterocycle are further preferable. In addition, Q₂ is preferably a carbamoyl group, and a carbamoyl group having a hydrogen atom on a nitrogen atom is particularly preferable.

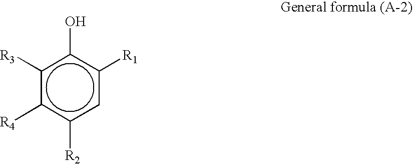

In the general formula (A-2), R₁ represents an alkyl group, an acyl group, an acylamino group, an sulfonamide group, an alkoxycarbonyl group, or a carbamoyl group. R₂ represents a hydrogen atom, a halogen atom, an alkyl group, an alkoxy group, an aryloxy group, an alkylthio group, an arylthio group, an acyloxy group, or a carbonic acid ester group. R₃ and R₅ each represent a group which is substitutable at a benzene ring exemplified as an example of a substituent for the general formula (A-1). R₃ and R₄ may couple with each other to form a condensed ring.

R₁ is preferably an alkyl group having 1 to 20 carbon atoms (e.g. methyl group, ethyl group, isopropyl group, butyl group, tert-octyl group, cyclohexyl group etc.), an acylamino group (e.g. acetylamino group, benzoylamino group, methylureido group, 4-cyanophenylureido group etc.), a carbamoyl group (n-butylcarbamoyl group, N,N-diethylcarbamoyl group, phenylcarbamoyl group, 2-chlorophenylcarbamoyl group, 2,4-dichlorophenylcarbamoyl group etc.), and an acylamino group (including ureido group and urethane group) is more preferable.

R₂ is preferably a halogen atom (more preferably chlorine atom, bromine atom), an alkoxy group (e.g. methoxy group, butoxy group, n-hexyloxy group, n-decyloxy group, cyclohexyloxy group, benzyloxy group etc.), or an aryloxy group (phenoxy group, naphthoxy group etc.).

R₃ is preferably a hydrogen atom, a halogen atom, an alkyl group having 1 to 20 carbon atoms, and a halogen atom is most preferable. R₄ is preferably a hydrogen atom, an alkyl group or an acylamino group, more preferably an alkyl group or an acylamino group. Examples of these preferable substituents are as in R₁. When R₄ is an acylamino group, it is preferable that R₄ and R₃ are taken together to form a carbostyryl ring.

When R₃ and R₄ in the general formula (A-2) are taken together to form a condensed ring, as a condensed ring, a naphthalene ring is particularly preferable. To a naphthalene ring may be bound the same substituent as that exemplified for the general formula (A-1). When the general formula (A-2) is a naphthol type compound, R₁ is preferably a carbamoyl group. Inter alia, a benzoyl group is particularly preferable. R₂ is preferably an alkoxy group or an aryloxy group, particularly preferably an alkoxy group.

Preferable examples of a development promoter in the invention will be shown below. However, the invention is not limited by them. 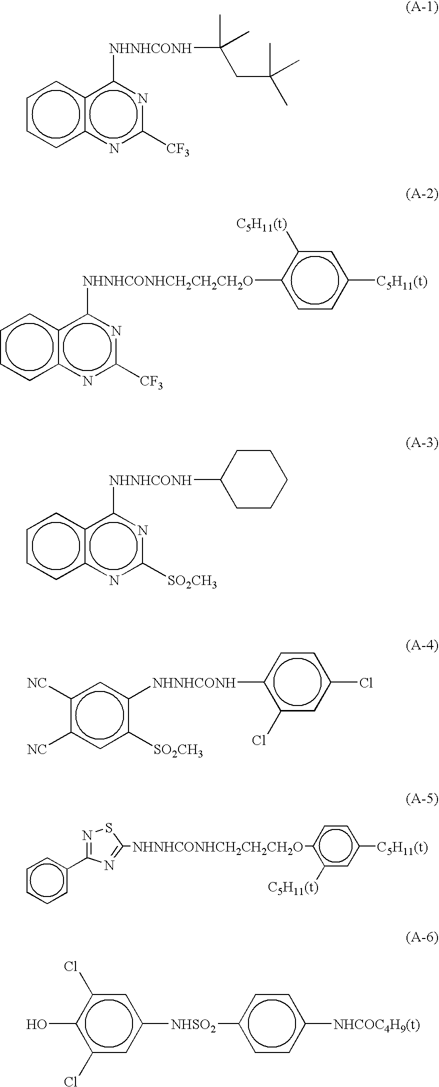 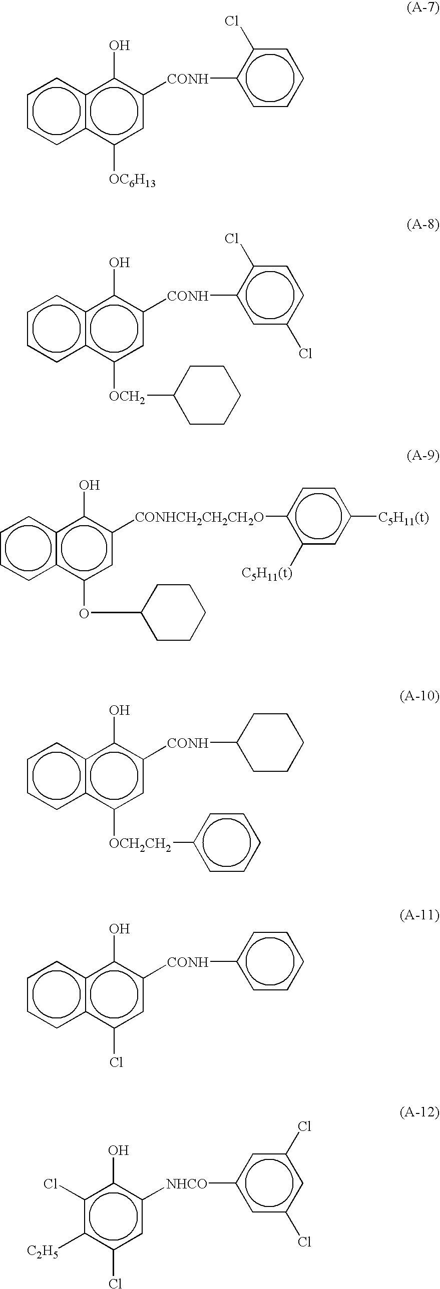
Hydrogen Bond-Forming Compound

When a reducing agent in the invention has an aromatic hydroxyl group (—OH) or amino group (—NHR, wherein R is hydrogen atom or alkyl group), in particular, the aforementioned bisphenol, it is preferable to jointly use a non-reductive compound having a group which can form a hydrogen bond with these groups.

Examples of a group which forms a hydrogen bond with a hydroxyl group or an amino group include a phosphoryl group, a sulfoxide group, a sulfonyl group, a carbonyl group, an amido group, an ester group, an urethane group, an ureido group, a tertiary amino group, and a nitrogen-containing aromatic group. Among them, preferable is a compound having a phosphoryl group, a sulfoxide group, an amido group (which has no >N—H group and is blocked like >N—Ra (Ra is a substituent other than H)), an urethane group (which has no >N—H group and is blocked like >N—Ra (Ra is a substituent other than H), or an ureido group (which has no >N—H group and is blocked like >N—Ra (Ra is a substituent other than H)).

In the invention, a particularly preferable hydrogen bond-forming compound is a compound represented by the following general formula (D):

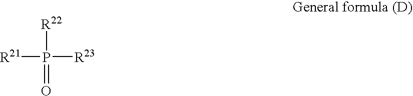

In the general formula (D), R² to R²³ each independently represent an alkyl group, an aryl group, an alkoxy group, an aryloxy group, an amino group or a heterocyclic group, and these groups may be unsubstituted or may have a substituent.

Examples of substituents when R²′ to R²³ have substituents include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group, and a phosphoryl group, and examples of a preferable substituent include an alkyl group or an aryl group, such as a methyl group, an ethyl group, an isopropyl group, a t-butyl group, a t-octyl group, a phenyl group, a 4-alkoxyphenyl group, and a 4-acyloxyphenyl group.

Examples of an alkyl group of R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, and a 2-phenoxypropyl group.

Examples of an aryl group include a phenyl group, a cresyl group, a xylyl group, a naphthyl group, a 4-t-butylphenyl group, a 4-t-octylphenyl group, a 4-anisidinyl group, and a 3,5-dichlorophenyl group.

Examples of an alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, a benzyloxy group and the like.

Examples of an aryloxy group include a phenoxy group, a cresyloxy group, an isopropylphenoxy group, a 4-t-butylphenoxy group, a naphthoxy group, a biphenyloxy group and the like.

Examples of an amino group include a dimethylamino group, a diethylamino group, a dibutylamino group, a dioctylamino group, a N-methyl-N-hexylamino group, a dicyclohexylamino group, a diphenylamino group, a N-methyl-N-phenylamino group and the like.

As R²¹ to R²³, an alkyl group, an aryl group, an alkoxy group, and an aryloxy group are preferable. In respect of the effect of the invention, it is preferable that at least one of R²¹ to R²³ is an alkyl group or an aryl group, and it is more preferable that two or more of R²¹ to R²³ are an alkyl group or an aryl group. In addition, from the viewpoint of inexpensive availability, it is preferable that R²¹ to R²³ are the same group.

Examples of a hydrogen bond-forming compound including a compound of the general formula (D) in the invention will be shown below, but the invention is not limited by them.

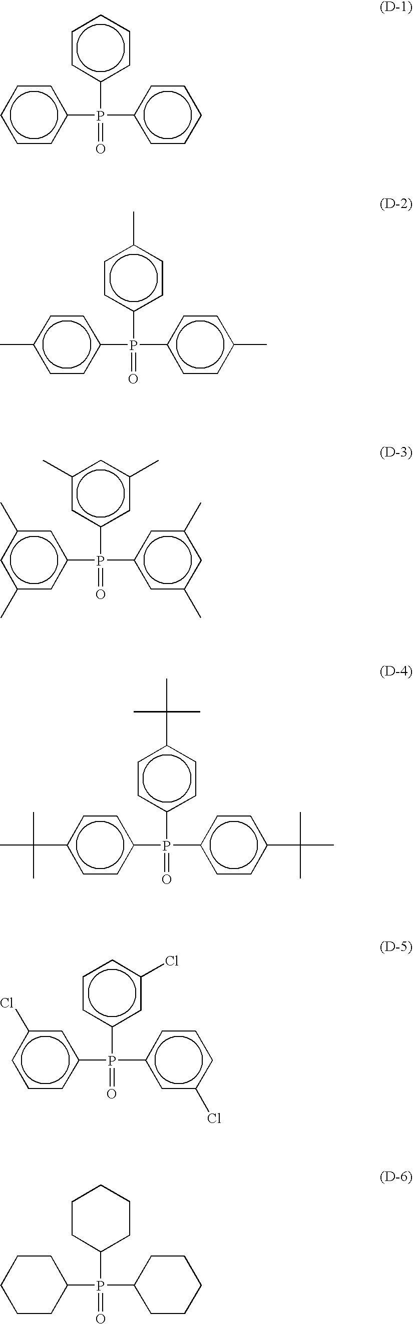

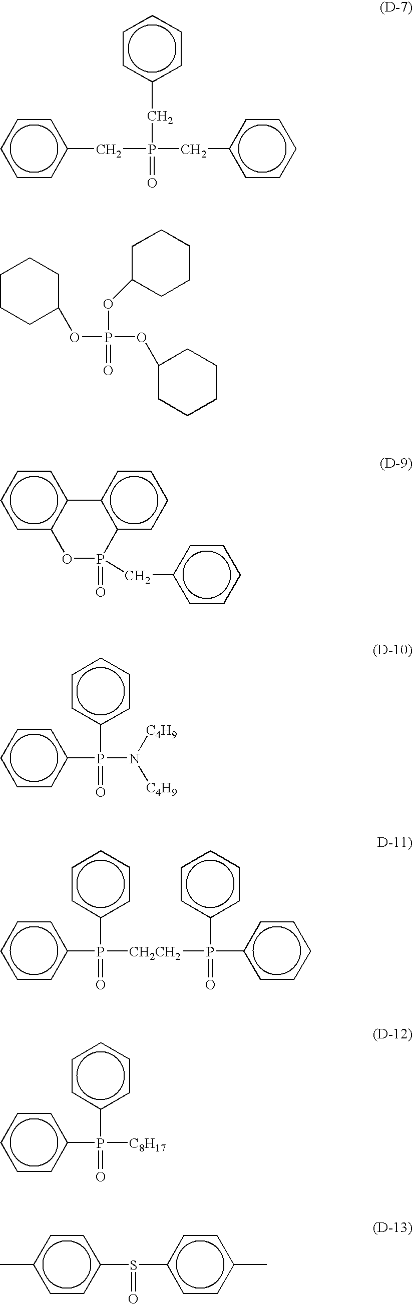

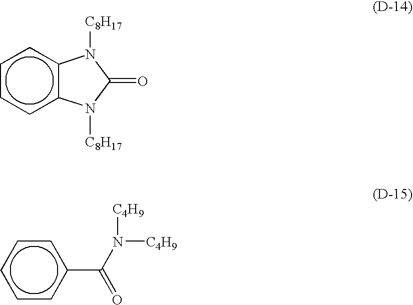

Examples of a hydrogen bond-forming compound include those described in EP No. 1096310, JP-A No. 2002-156727, and Japanese Patent Application No. 2001-124796.

The compound of the general formula (D) of the invention can be made to be contained in a coating solution in the solution form, the emulsified dispersion form or the solid-dispersed fine particle dispersion form like a reducing agent, and can be used in a photosensitive material. It is preferable to use as a solid dispersion. The compound of the invention forms a hydrogen bond-forming complex with a compound having a phenolic hydroxyl group or an amino group in the solution state, and can be isolated as a complex in the crystal state depending on a combination of a reducing agent and the compound of the general formula (D) of the invention.

It is particularly preferable to use the thus isolated crystal powder as a solid dispersed fine particle dispersion in order to obtain the stable performance. In addition, a method of mixing a reducing agent and the compound of general formula (D) of the invention in the form of a powder, and forming a complex at dispersing with a sand grinder mill or the like using an appropriate dispersing agent may be also preferably used.

The compound of the general formula (D) of the invention is used in a range of, preferably 1 to 200% by mol, more preferably in a range of 10 to 150% by mol, further preferably in a range of 20 to 100% by mol relative to a reducing agent.

Explanation of Silver Halide

1) Halogen Composition

Photosensitive silver halide used in the invention is not particularly limited in the halogen composition, and silver chloride, silver bromide chloride, silver bromide, silver bromide iodide, silver bromide chloride iodide and silver iodide can be used. Among them, silver bromide, silver bromide iodide and silver iodide are preferable. A distribution of the halogen composition in a particle may be uniform, or the halogen composition may be changed step-wisely, or may be changed continuously. In addition, a silver halide particle having a core/shell structure can be preferably used. A preferable structure is a double to quintuple structure, and a core/shell particle having a double to quartuple structure can be more preferably used. In addition, the technique of localizing silver bromide or silver iodide on the surface of a silver chloride, silver bromide or silver bromide chloride particle can be preferably used.

2) Particle Forming Method

A method of forming photosensitive silver halide is well known in the art and, for example, methods described in Research Disclosure, June, 1978, No. 17029, and U.S. Pat. No. 3,700,458 can be used. Specifically, a method of preparing photosensitive silver halide by adding a silver donor compound and a halogen donor compound to a solution of gelatin or other polymer and, thereafter, mixing the photosensitive silver halide with an organic silver salt is used. Alternatively, a method described in JP-A No. 11-119374, paragraph numbers 0217 0224, and a method described in JP-A Nos. 11-352627 and 2000-347335 are preferable.

3) Particle Size

In order to suppress whitening after image formation low, a particle size of photosensitive silver halide is preferably small, specifically, 0.20 μm or smaller, more preferably not smaller than 0.01 μm and not larger than 0.15 μm, further preferably not smaller than 0.02 μm and not larger than 0.12 μm. A particle size herein refers to a diameter when converted into a circular image having the same area as the projected area of a silver halide particle (projected area of a main plane in the case of plate particle).

4) Particle Shape

Examples of a shape of a silver halide particle include a cube, an octahedron, a plate-like particle, a spherical particle, a bar-like particle, a potato-like particle and the like. In the invention, a cubic particle is particularly preferable. A particle in which a corner of a silver halide particle is round may be preferably used. A plane index (Miller index) of an outer surface of a photosensitive silver halide particle is not particularly limited, but it is preferable that a ratio occupied by a [100] plane having the high Spectral sensitizing efficacy when a Spectral sensitizing dye is adsorbed is high. The ratio is preferably 50% or more, more preferably 65% or more, further preferably 80% or more. A rate of a Miller index [100] plane can be obtained by a method described in T. Tani; J. Imaging Sci., 29, 165 (1985) utilizing adsorption dependency of a [111] plane and a [100] plane at adsorption of a sensitizing dye.

5) Heavy Metal

The photosensitive silver halide particle in the invention can contain a metal or a metal complex of Groups 8 to 10 in Periodic Table (showing Group 1 to Group 18). A metal or a central metal of a metal complex of Group 8 to Group 10 in Periodic Table is preferably rhodium, ruthenium or iridium. These metal complexes may be one kind of, or two or more kinds of complexes of homogenous metals and heterogenous metals may be used jointly. The content is preferably in a range of 1×10⁻⁹ mol to 1×10−3 relative to 1 mol of silver. These heavy metals and metal complexes and methods of adding them are described in JP-A Nos. 7-225449, 11-65021, paragraph numbers 0018 to 0024, and JP-A No. 11-119374, paragraph numbers 0227 to 0240.

In the invention, a silver halide particle in which a hexacyano metal complex is present on the particle superficialmost surface is preferable. Examples of the hexacyano metal complex include [Fe(CN)₆]⁴—, [Fe(CN)₆]³—, [Ru(CN)₆]⁴—, [Os(CN)₆]⁴—, [Co(CN)₆]³—, [Rh(CN)₆]³—, [Ir(CN)₆]³−, [Cr(CN)₆]³— and [Re(CN)₆]³—. In the invention, a hexacyano Fe complex is preferable.

Since the hexacyano metal complex is present as an ionic form in an aqueous solution, a counter-positive ion is not important, but it is preferable to use an alkali metal ion such as a sodium ion, a potassium ion, a rubidium ion, a cesium ion and a lithium ion, an ammonium ion, or an alkylammonium ion (e.g. tetramethylammonium ion, tetraethylammonium ion, tetrapropylammonium ion, tetra(n-butyl)ammonium ion), which is easily compatible with water, and is suitable for precipitation procedures of a silver halide emulsion.

The hexacyano metal complex may be added by kneading with a mixed solvent of water and an appropriate organic solvent which is compatible with water (e.g. alcohols, ethers, glycols, ketones, esters, amides etc.), or with gelatin.

An amount of the hexacyano metal complex to be used is preferably not smaller than 1×10⁻⁵ mol and not larger than 1×10⁻² mol, more preferably not smaller than 1×10⁻⁴ mol and not larger than 1×10⁻³ mol per 1 mol of silver.

In order that the hexacyano metal complex is present on the superficalmost surface of a silver halide particle, after addition of an aqueous silver nitrate solution used for forming a particle is completed, the hexacyano metal complex is directly added before completion of a charging step before a chemically sensitizing step of performing chalcogen sensitization such as sulfur sensitization, selenium sensitization and tellurium sensitization or noble metal sensitization such as gold sensitization, during a water washing step, during a dispersing step, or before a chemically sensitizing step. In order that a silver halide fine particle is not grown, it is preferable to add the hexacyano metal complex rapidly after particle formation, and it is preferable to add before completion of a charging step.

Addition of the hexacyano metal complex may be initiated after 96% by weight of a total amount of silver nitrate to be added for particle formation is added, and it is more preferable to initiate after 98% by weight is added, and it is particularly preferable to initiate after 99% by weight is added.

When the hexacyano metal complex is added after an aqueous silver nitrate solution is added immediately before completion of particle formation, the complex can be adsorbed on the superficialmost surface of a silver halide particle, and a majority of the complex forms a hardly-soluble salt with a silver ion on the particle surface. Since this silver salt of hexacyanoferrate (II) is a salt which is less soluble than AgI, re-dissolution due to a fine particle can be prevented, and it becomes possible to prepare a silver halide fine particle having a small particle size.

Further, a metal atom (e.g. [Fe(CN)₆)⁴⁻) which can be contained in a silver halide particle which is used in the invention, a desalting method and a chemically sensitizing method for a silver halide emulsion are described in JP-A No. 11-84574, paragraph numbers 0046 to 0050, JP-A No. 11-65021, paragraph numbers 0025 to 0031, and JP-A No. 11-119374, paragraph numbers 0242 to 0250.

6) Gelatin

As gelatin to be contained in a photosensitive silver halide emulsion used in the invention, various gelatins can be used. Since it is necessary to maintain the dispersed state better in an organic silver salt-containing coating solution of a photosensitive silver halide emulsion, it is preferable to use gelatin having a molecular weight of 10,000 to 1,000,000. Alternatively, it is preferable to phthalation-treat a substituent of gelatin. The gelatin may be used at particle formation or at dispersing after desalting treatment, but it is preferable to use at particle formation.

7) Sensitizing Dye

As a sensitizing dye which can be applied to the invention, a sensitizing dye which can spectrally-sensitize a silver halide particle at a desired wavelength region upon adsorption onto a silver halide particle and has the spectral sensitivity suitable for the spectral property of an exposing light source can be advantageously selected. A sensitizing dye and a method of adding the same are described in JP-A No. 11-65021, paragraph numbers 0103 to 0109, a compound represented by the general formula (II) of JP-A 10-186572, a dye represented by the general formula (I) of JP-A No. 11-119374, a pigment described in paragraph number 0106, U.S. Pat. Nos. 5,510,236, 3,871,887, Example 5, a dye disclosed in JP-A Nos. 2-96131, 59-48753, EP Laid-Open No. 0803764A1, page 19, line 38 to page 20, line 35, JP-A Nos. 2001-272747, 2001-290238, 2002-23306 and the like. These sensitizing dyes may be used alone, or may be used by combining two or more. A time for adding a sensitizing dye to a silver halide emulsion in the invention is preferably after a desalting step and by coating, more preferably after desalting and before completion of chemical aging.

An amount of a sensitizing dye to be used in the invention can be a desired amount in conformity with the sensitivity and the performance of fog, and preferably 10⁻⁶ to 1 mol, more preferably 10⁻⁴ to 10⁻¹ mol per 1 mol of silver halide in a photosensitive layer.

In the invention, in order to improve the spectral sensitizing efficacy, a strong sensitizer can be used. Examples of the strong sensitizer used in the invention include compounds described in EP Laid-Open No. 587,338, U.S. Pat. Nos. 3,877,943, 4,873,184, JP-A Nos. 5-341432, 11-109547, 10-111543 and the like.

8) Chemical Sensitization

It is preferable that a photosensitive halide particle in the invention is chemically sensitized by a sulfur sensitizing method, a selenium sensitizing method or a tellurium sensitizing method. As a compound which is preferably used in a sulfur sensitizing method, a selenium sensitizing method and a tellurium sensitizing method, the known compounds, for example, compounds described in JP-A No. 7-128768 can be used. In the invention, tellurium sensitization is particularly preferable, and compounds described in the literatures described in JP-A No. 11-65021, paragraph number 0030, and compounds represented by the general formulae (II), (III) and (IV) in JP-A No. 5-313284 are more preferable.

It is preferable that a photosensitive silver halide particle in the invention is chemically sensitized by a gold sensitizing method alone or in a combination with the aforementioned chalcogen sensitization. As a gold sensitizer, gold valence of +1 valence or +3 valence is preferable and, as a gold sensitizer, gold compounds which are usually used are preferable. Representative examples of aurate chloride, aurate bromide, potassium chloroaurate, potassium bromoaurate, auric trichloride, potassium auric thiocyanate, potassium iodoaurate, tetracyanoauric acid, ammonium aurothiocyanate and pyridyltrichlorogold are preferable. Alternatively, gold sensitizers described in U.S. Pat. No. 5,858,637 and Japanese Patent Application No. 2001-79450 are preferably used.

In the invention, chemical sensitization may be performed at any time as far as it is after particle formation and before coating, such as after desalting (1) before spectral sensitization, (2) at the same time with spectral sensitization, (3) after spectral sensitization (4) immediately before coating etc.

An amount of a sulfur, selenium or tellurium sensitizer used in the invention varies depending on a silver halide particle to be used, chemical aging conditions and the like, and around 10⁻⁸ to 10⁻² mol, preferably around 10⁻⁷ to 10⁻³ mol is used per 1 mol of silver halide.

An amount of a gold sensitizer to be added varies depending on various conditions, and a standard is 10⁻⁷ mol to 10⁻³ mol, more preferably 10⁻⁶ mol to 5×10⁻⁴ mol per 1 mol of silver halide.

The conditions of chemical sensitization in the invention are not particularly limited, but a pH is 5 to 8, a pAg is 6 to 11, and a temperature is around 40 to 95° C.

A thiosulfonic acid compound may be added to a silver halide emulsion used in the invention by a method shown in EP Publication No. 293,917.

It is preferable that a reducing agent is used in a photosensitive silver halide particle in the invention. As a specific compound for a reductive sensitizing method, ascorbic acid and thiourea dioxide are preferable and, besides, it is preferable to use stannous chloride, aminoiminomethanesulfinic acid, a hydrazine derivative, a borane compound, a silane compound, a polyamine compound or the like. A reductive sensitizer may be added at any stage of a photosentitive emulsion preparing step from a crystal growth step to a preparing step immediately before coating. In addition, it is preferable that reductive sensitization is performed by aging while retaining a pH of an emulsion at 7 or higher and a pAg at 8.3 or smaller, and it is also preferable that reductive sensitization is performed by introducing a single addition part of a silver ion during particle formation.

It is preferable that a photosensitive silver halide emulsion in the invention contains a FED sensitizer (Fragmentable electron donating sensitizer) as a compound which generates two electrons per one photon. As the FDE sensitizer, compounds described in U.S. Pat. Nos. 5,747,235, 5,747,236, 6054260, 5994051 and Japanese Patent Application No. 2001-86161 are preferable. The FED sensitizer is preferably added at any stage of a photosensitive emulsion preparing step from a crystal growing step to a preparing step immediately before coating. An addition amount varies depending on various conditions, and a standard is 10⁻⁷ mol to 10⁻¹ mol, preferably 10⁻⁶ mol to 5×10⁻² mol per 1 mol silver halide.

9) Joint Use of a Plurality of Silver Halides

A photosensitive silver halide emulsion in a photosensitive material used in the invention may be one kind, or two or more kinds (e.g. having different average particle sizes, different halogen compositions, different crystal habits, different chemical sensitization conditions) may be used jointly. Gradation can be regulated by using a plurality of photosensitive silver halides having the different sensitivities. Examples of the techniques regarding them include those described in JP-A Nos. 57-119341, 53-106125, 47-3929, 48-55730, 46-5187, 50-73627, and 57-15041. It is preferable that a sensitivity difference is 0.2 logE or more in each emulsion.

10) Coating Amount

An amount of photosensitive silver halide to be used is preferably 0.03 to 0.6 g/m², more preferably 0.05 to 0.4 g/m², most preferably 0.07 to 0.3 g/m² in terms of a coating silver amount per 1 m² of a photosensitive material, and photosensitive silver halide is preferably not smaller than 0.01 mol and not larger than 0.5 mol, more preferably not smaller than 0.02 and not larger than 0.3 mol, more preferably not smaller than 0.03 mol and not larger than 0.2 mol.

11) Mixing of Photosensitive Silver Halide and Organic Silver Salt

For a method of mixing separately prepared photosensitive silver halide and organic silver salt and mixing conditions, there are a method of mixing separately having prepared silver halide particle and organic silver salt with a high speed stirrer, a ball mill, a sand mill, a colloid mill, a vibration mill, a homogenizer or the like, and a method of mixing photosensitive silver halide for which preparation has been completed at any timing during preparation of an organic silver salt, but a method is not particularly limited as far as the effect of the invention is sufficiently manifested. In addition, mixing of two or more kinds of organic silver salt water dispersions and two or more kinds of photosensitive silver salt water dispersions is a preferable method for regulating the photographic properties.

12) Mixing of Silver Halide into Coating Solution

A preferable time for adding silver halide in the invention to an image forming layer coating solution is from 180 minutes before coating to immediately before coating, preferably from 60 minutes before to 10 seconds before, and a mixing method and mixing conditions are not particularly limited as far as the effect of the invention is sufficiently manifested. As a specific mixing method, there are a method of mixing in a tank so that an average retention time calculated from an addition flow rate and an amount of a solution to be supplied to a coater becomes a desired time, and a method of employing a static mixer described in “Liquid Mixing Technology” authored by N. Harnby, M. F. Edwards, A. W. Mienow, translated by Koji TAKAHASHI (published by The Nikkan Kogyo Shimbun, Ltd., 1989), Chapter 8.

Explanation of Binder

1) Kind of Binder

As a binder in an organic silver salt-containing layer in the invention, any polymers may be used, a preferable binder is transparent or translucent, and is generally colorless, and examples thereof include a natural resin, polymer and copolymer, a synthetic resin, polymer and copolymer, and other media for forming a film, for example, gelatins, rubbers, poly(vinyl alcohols), hydroxyethylcelluloses, cellulose acetates, cellulose acetate butyrates, poly(vinylpyrrolidones), casein, starch, poly(acrylic acids), poly(methylmethacrylic acids), poly(vinyl chlorides), poly(methacrylic acids), styrene-maleic anhydride copolymers, styrene-acrylonitrile copolymers, styrene-butadiene copolymers, poly(vinyl acetals) (e.g. poly(vinyl formal) and poly(vinyl butyral)), poly(esters), poly(urethanes), phenoxy resin, poly(vinylidene chlorides), poly(epoxides), poly(carbonates), poly(vinyl acetates), poly(olefins), cellulose esters, and polyamides. A binder may be covering-formed from water or an organic solvent or an emulsion.

2) Tg of Binder

In the invention, a glass transition temperature of a binder which can be used jointly in a layer containing an organic silver salt is preferably not lower than 0° C. and not higher than 80° C. (hereinafter, referred to as high Tg binder in some cases), more preferably 10° C. to 70° C., further preferably not lower than 15° C. and not higher than 60° C.

Tg is calculated by the following equation herein.
1/Tg=Σ(Xi/Tgi)
Here, a polymer is regarded such that n monomer components from i=1 to i=n are copolymerized. Xi is a weight fraction of a i^{th} monomer (ΣXi=1), and Tgi is a glass transition temperature (absolute temperature) of a homopolymer of a i^{th} monomer. Σ means that a sum from i=1 to i=n is taken. As a value (Tgi) of a glass transition temperature of a homopolymer of each monomer, a value in Polymer Handbook (3^{rd} Edition) (authored by J. Brandrup, E. H. Immergut (Weley-Interscience, 1989)) is adopted.

As a binder, two or more kinds may be used if necessary. Alternatively, a binder having a glass transition temperature of 20° C. or higher and a binder having a glass transition temperature lower than 20° C. may be used by combining them. When two or more kinds of polymers having different Tgs are used by blending, it is preferable that a weight average Tg is within the above range.

3) Aqueous Coating

In the invention, it is preferable to coat and dry a coating solution in which 30% by weight or more of a solvent is water, to form a film of an olganosilver salt-containing layer.

In the invention, when an olganosilver salt-containing layer is formed by coating and drying a coating solution in which 30% by weight or more of a solvent is water, or when a binder in an olganosilver salt-containing layer is soluble or dispersible in an aqueous solvent (water solvent), in particular, when a coating solution is composed of a latex of a polymer in which an equilibrium water content at 25° C. and 60% RH is 2% by weight or smaller, the performance is improved. The most preferable form is obtained by adjusting so that the ion conductivity is 2.5 mS/cm or smaller. As such an adjusting method, there is a method of purification treatment using a separation-functioning membrane after polymer synthesis.

The aqueous solvent in which a polymer is soluble or dispersible is water, or a mixture of water and 70% by weight or smaller of a water-compatible organic solvent. Examples of a water-compatible organic solvent include alcohols such as methyl alcohol, ethyl alcohol, propyl alcohol and the like, cellosolves such as methyl cellosolve, ethyl cellosolve, butyl cellosolve and the like, ethyl acetate, and dimethylformamide.

In addition, the “equilibrium water content at 25° C. and 60% RH” can be expressed using a weight W1 of a polymer which is in moisture conditioning equilibrium under the atmosphere at 25° C. and 60% RH and a weight W0 of a polymer which is in the absolute dry state at 25° C. as follows:
Equilibrium water content at 25° C. and 60% RH=[(W1−W0)/W0]×100% by weight]

Regarding a definition of a water content and a method of measuring the content, reference may be made to Polymer Technology Course 14, “Polymer Material Test Method” (edited by Polymer Society, Chijinshokan Co., Ltd.).

An equilibrium water content at 25° C. and 60% RH of a binder polymer in the invention is preferably 2% by weight or smaller, more preferably not smaller than 0.01% by weight and not larger than 1.5% by weight, more preferably not smaller than 0.02% by weight and not larger than 1% by weight.

In the invention, a polymer which is dispersible in an aqueous solvent is particularly preferable. The dispersed state may be any of a latex in which a fine particle of water-insoluble hydrophobic polymer is dispersed, and a dispersion in which a polymer molecule is dispersed in the molecular state or by forming a micelle. A latex-dispersed particle is more preferable. An average particle diameter of a dispersed particle is in a range of 1 to 50000 nm, preferably in a range of 5 to 1000 nm, more preferably in a range of 10 to 500 nm, further preferably in a range of 50 to 200 nm. A particle diameter distribution of a dispersed particle is not particularly limited, but a wide particle diameter dispersion or a monodisperse particle diameter dispersion. Use of two or more kinds of monodisperse particle diameter dispersions by mixing is a preferable using method from the viewpoint of control of the physical properties of a coating solution.

As a preferable embodiment of a polymer which is dispersible in an aqueous solvent in the invention, hydrophobic polymers such as acrylic type polymer, poly(esters), rubbers (e.g. SBR resin), poly(urethanes), poly(vinyl chlorides), poly(vinyl acetates), poly(vinylidene chlorides), poly(olefins) and the like can be preferably used. These polymers may be straight polymers or branched polymers, may be cross-linked polymers, or may be a so-called homopolymer obtained by polymerizing a single monomer, or may be a copolymer obtained by polymerizing two or more kinds of monomers. A copolymer may be a random copolymer or a block copolymer. A molecular weight of these polymers is 5000 to 1000000, preferably 10000 to 200000 as a number average molecular weight. When a molecular weight is too small, the dynamic strength of an image forming layer is insufficient and, when a molecular weight is too large, the film forming property is worse, being not preferable. In addition, a cross-linking polymer latex is particularly preferably used.

4) Embodiment of Latex

Examples of a preferable polymer latex are as follows: hereinafter, examples are expressed using a raw material monomer, a numerical value in a parenthesis is % by weight, a molecular weight is a number average molecular weight. When a polyfunctional monomer is used, since a cross-linked structure is formed, concept of a molecular weight can not be applied and, thus, “cross-linking” is described, and description of a molecular weight is omitted. Tg represents a glass transition temperature.
P-1; -MMA(70)-EA(27)-MAA(3)-latex (molecular weight 37000, Tg 61° C.)
P-2; -MMA(70)-2EHA(20)-St(5)-AA(5)-latex (molecular weight 40000, Tg 59° C.)
P-3; -St(50)-Bu(47)-MMA(3)-latex (cross-linking, Tg-17° C.)
P-4; -St(68)-Bu(29)-AA(3)-latex (cross-linking, Tg17° C.)
P-5; -St(71)-Bu(26)-AA(3)-latex (cross-linking, Tg24° C.)
P-6; -St(70)-Bu(27)-IA(3)-latex (cross-linking)
P-7; -St(75)-Bu(24)-AA(1)-latex (cross-linking, Tg 29° C.)
P-8; -St(60)-Bu(35)-DVB(3)-MAA(2)-latex (cross-linking)
P-9; -St(70)-Bu(25)-DVB(2)-AA(3)-latex (cross-linking)
P-10; -VC(50)-MMA(20)-EA(20)-AN(5)-AA(5)-latex (molecular weight 80000)
P-11; -DVC(85)-MMA(5)-EA(5)-MAA(5)-latex (molecular weight 67000)
P-12; -Et(90)-MAA(10)-latex (molecular weight 12000)
P-13; -St(70)-2EHA(27)-AA(3) latex (molecular weight 130000, Tg 43° C.)
P-14; -MMA(63)-EA(35)-AA(2) latex (molecular weight 33000, Tg 47° C.)
P-15; -St(70.5)-Bu(26.5)-AA(3)-latex (cross-linking, Tg 23° c)
P-16; -St(69.5)-Bu(27.5)-AA(3)-latex (cross-linking, Tg 20.5° C.)

Abbreviations of the above structures represent the following monomers: MMA; methyl methacrylate, EA; ethyl acrylate, MAA; methacrylic acid, 2EHA; 2-ethylhexyl acrylate, St; styrene, Bu; butadiene, AA; acrylic acid, DVB; divinylbenzene, VC; vinyl chloride, AN; acrylonitrile, VDC; vinylidene chloride, Et; ethylene, IA; itaconic acid.

The above-described polymer latexes are sold, and the following polymers can be utilized. Examples of the acrylic type polymer include Sebian A-4635, 4718 and 4601 (all trade names, manufactured by Daicel Chemical Industries, Ltd.), Nipol Lx 811, 814, 821, 820 and 857 (all trade names, manufactured by Nippon Zeon Co., Ltd.), examples of poly(esters) include FINETEX ES650, 611, 675 and 850 (all trade names, manufactured by Dainippon Ink and Chemicals, Incorporated), WD-size, WMS (all trade names, manufactured by Eastman Chemical Company), examples of poly(urethanes) include HYDRAN AP10, 20, 30 and 40 (all trade names, manufactured by Dainippon ink and Chemicals, Incorporated), examples of rubbers include LACSTAR 7310K, 3307B, 4700H and 7132C (all trade names, manufactured by Dainippon Ink and Chemicals, Incorporated), Nipol Lx416, 410, 438C and 2507 (all trade names, manufactured by Nippon Zeon Co., Ltd.), examples of poly(vinyl chlorides) include G351 and G576 (all trade names, manufactured by Nipon Zeon Co.), examples of poly(vinylidene chlorides) include L502 and L513 (all trade names, manufacture by Asahi Chemical Industry Co., Ltd.), and examples of poly(olefins) include Chemipearl S120 and SA100 (all trade names, manufactured by Mitsui Petrochemical Industries, Ltd.).

These polymer latexes may be used alone, or two or more kinds may be blended if necessary.

5) Preferable Latex

As a polymer latex used in the invention, in particular, a latex of a styrene-butadiene copolymer is preferable. A weight ratio of a monomer unit of styrene and a monomer unit of butadiene in a styrene-butadiene copolymer is preferably 40:60 to 95:5. In addition, a ratio of styrene occupying in a copolymer of a monomer unit of styrene and a monomer unit of butadiene is preferably 60 to 99% by weight. In addition, a polymer latex in the invention contains acrylic acid or methacrylic acid at preferably 1 to 6% by weight, more preferably 2 to 5% by weight relative to a sum of styrene and butadiene. It is preferable that a polymer latex in the invention contains acrylic acid. A preferable molecular weight range is as described above.

Examples of a latex of a styrene-butadiene copolymer which is preferably used in the invention include aforementioned P-3 to P-8, 15, commercially available LACSTAR-3307B, 7132C, Nipol Lx416 and the like.

6) Solvent for Preferable Coating Solution

A solvent (herein, a solvent and a dispersing medium are expressed as a solvent collectively for simplicity) of an olganosilver salt-containing layer coating solution for a photosensitive material in the invention is preferably an aqueous solvent containing 30% by weight or more of water. As a component other than water, arbitrary water-compatible organic solvents such as methyl alcohol, ethyl alcohol, isopropyl alcohol, methyl cellosolve, ethyl cellosolve, dimethylformamide and ethyl acetate may be used. A water content of a solvent for a coating solution is preferable 50% by weight or larger, more preferably 70% by weight or larger. Examples of a preferable solvent composition include, in addition to water, water/methyl alcohol=90/10, water/methyl alcohol=70/30, water/methyl alcohol/dimethylformamide=80/15/5, water/methyl alcohol/ethyl cellosolve=85/15/5, and water/methyl alcohol/isopropyl alcohol=85/10/5(numerical value is in % by weight).

7) Others

Hydrophilic polymers such as gelatin, polyvinyl alcohol, methylcellulose, hydroxypropylcellulose and carboxymethylcellulose may be added to an olganosilver salt-containing layer of a photosensitive material in the invention if necessary. An amount of these hydrophilic polymers to be added is preferably 30% by weight or smaller, more preferably 20% by weight or smaller of a total binder in an organic silver salt-containing layer.

It is preferable that an organic silver-salt containing layer (i.e. image forming layer) in the invention is formed using a polymer latex. An amount of a binder in an organic silver-salt-containing layer is such that a weight ratio of total binder/organic silver salt is 1/10 to 10/1, more preferably in a range of 1/3 to 5/1, further preferably in a range of 1/1 to 3/1.

In addition, such the organic silver salt-containing layer is usually also a photosensitive layer (emulsion layer) containing photosensitive silver halide which is a photosensitive silver salt, and a weight ratio of total binder/silver halide is in a range of 400 to 5, more preferably a range of 200 to 10.

An amount of a total binder in an image forming layer in the invention is preferably in a range of 0.2 to 30 g/m², more preferably in a range of 1 to 15 g/m², further preferably in a range of 2 to 10 g/m². A cross-linking agent for cross-linking, or a surfactant for improving the coating property may be added to an image forming layer in the invention.

Explanation of Fog Preventing Agent

Examples of a fog preventing agent, a stabilizer and a stabilizer precursor which can be used in the invention include those described in JP-A No. 10-62899, paragraph number 0070, EP Publication No. 0803764A1, page 20, line 57 to page 21, line 7, compounds described in JP-A Nos. 9-281637, 9-329864, and compounds described in U.S. Pat. Nos. 6,083,681, 6,083,681, EP No. 1048975. In addition, a fog preventing agent which is preferably used in the invention is an organic halide, and examples thereof include those disclosed in JP-A No. 11-65021, paragraph numbers 0111 to 0112. In particular, organic halogen compounds represented by the formula (P) in JP-A No. 2000-284399, organic polyhalogen compounds represented by the general formula (II) in JP-A No. 10-339934, and organic polyhalogen compounds described in JP-A Nos. 2001-31644 and 2001-33911 are preferable.

1) Polyhalogen Compound

Preferable organic polyhalogen compounds which are preferable in the invention will be specifically explained below. A polyhalogen compound which is preferable in the invention is a compound represented by the following general formula (H).
Q-(Y)ₙ—C(Z₁)(Z₂)X General formula (H)

In the general formula (H), Q represents an alkyl group, an aryl group or a heterocyclic group; Y represents a divalent linking group; Z₁ and Z₂ each represent a halogen atom; X represents a hydrogen atom or an electron withdrawing group; and n represents 0 or 1.

In the general formula (H), Q is preferably an aryl group or a heterocyclic group.

In the general formula (H), when Q is a heterocyclic group, a nitrogen-containing heterocyclic group containing 1 or 2 nitrogen atom(s) is preferable, and a 2-pyridyl group and a 2-quinolyl group are particularly preferable.

In the general formula (H), when Q is an aryl group, Q represents a phenyl substituted with an electron withdrawing group in which a substituent constant σp of Hammett takes a positive value. Regarding a substituent constant of Hammett, reference can be made to Journal of Medicinal Chemistry, 1973, Vol. 16, No. 11, 1207-1216 and the like. Examples of such the electron withdrawing group include a halogen atom (fluorine atom (σp value: 0.06), chlorine atom (σp value: 0.23), bromine atom (σp value: 0.23), iodine atom (σp value: 0.18)), a trihalomethyl group (tribromomethyl (σp value: 0.29), trichloromethyl (σp value: 0.33), trifluoromethyl (σp value: 0.54)), acyanogroup (σp value: 0.66), anitrogroup (σp value: 0.78), an aliphatic, aryl or heterocyclic sulfonyl group (e.g. methanesulfonyl (σp value: 0.72)), an aliphatic, aryl or heterocyclic acyl group (e.g. acetyl (σp value: 0.50), benzoyl (σp value: 0.43)), an alkynyl group (e.g. C≡CH (σp value: 0.23)), an aliphatic, aryl or heterocyclic oxycarbonyl group (e.g. methoxycarbonyl (σp value: 0.45), phenoxycarbonyl (σp value: 0.44)), a carbamoyl group (σp value: 0.36), a sulfamoyl group (σp value: 0.57), a sulfoxide group, a heterocyclic group, a phosphoryl group and the like. A σp value is preferably in a range of 0.2 to 2.0, more preferably in a range of 0.4 to 1.0. As an electron withdrawing group, a carbamoyl group, an alkoxycarbonyl group, an alkylsulfonyl group and an alkylphosphoryl group are particularly preferable and, inter alia, a carbamoyl group is most preferable.

X is preferably an electron withdrawing group, more preferably a halogen atom, an aliphatic, aryl or heterocyclic sulfonyl group, an aliphatic, aryl or heterocyclic acyl group, an aliphatic aryl or heterocyclic oxycarbomyl group, a carbamoyl group and a sulfamoyl group, particularly preferable a halogen atom. Among halogen atoms, a chlorine atom, a bromine atom and an iodine atom are preferable, a chlorine atom and a bromine atom are further preferable, and a bromine atom is particularly preferable.

Y represents preferably —C(═O)—, —SO— or —SO₂—, more preferably —C(═O)— or —SO₂—, particularly preferably —SO₂—. A symbol n represents 0 or 1, preferably 1.

Examples of the compound of the general formula (H) in the invention will be shown below.

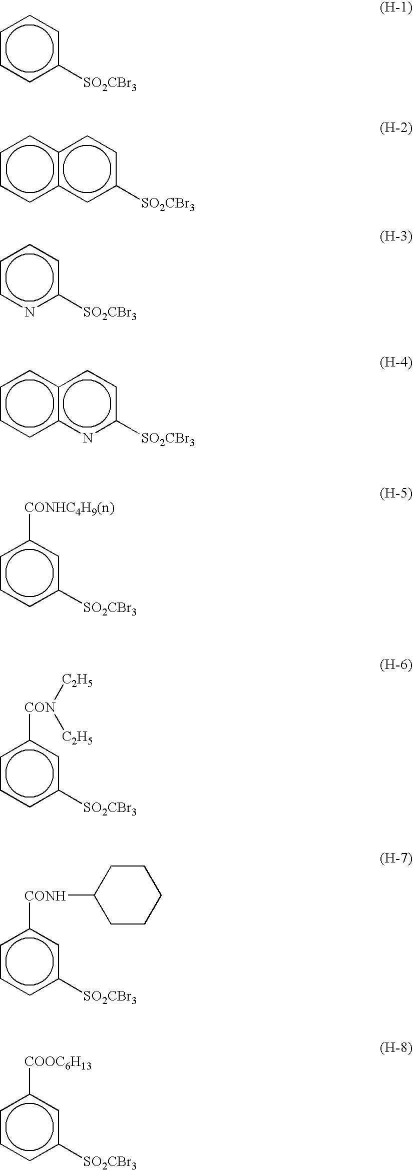

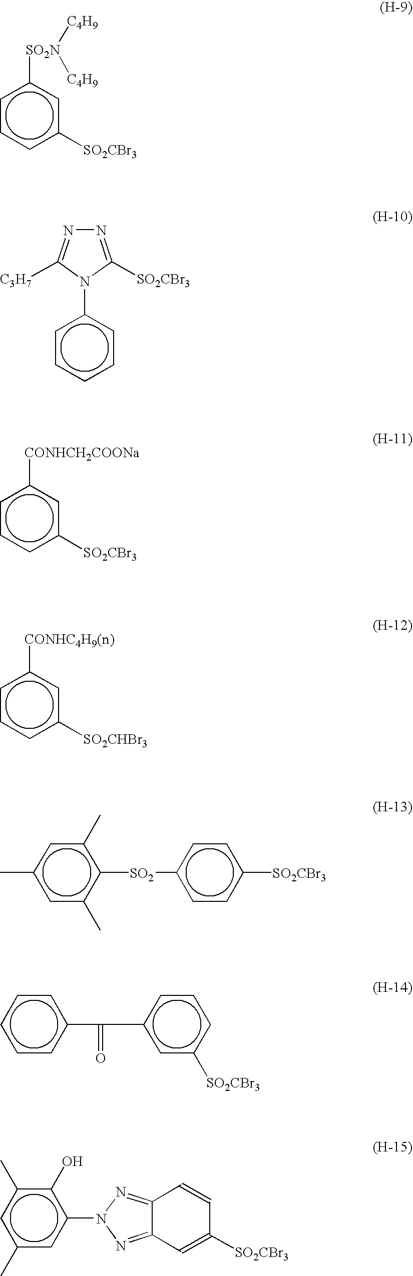

Examples of a preferable polyhalogen compound in the invention other than those described above include compounds described in JP-A Nos. 2001-31644, 2001-56526, and 2001-209145.

The compound represented by the general formula (H) in the invention is used at a range of 10⁻⁴ to 1 mol, more preferably at a range of 10⁻³ to 0.5 mol, further preferably at a range of 1×10⁻² to 0.2 mol per 1 mol of a non-photosensitive silver salt in an image forming layer.

In the invention, examples of a method inclusion of a fog preventing agent in a photosensitive material include the method described in the method of the inclusion of a reducing method, and it is also preferable that an organic polyhalogen compound is added as a solid fine particle dispersion.

2) Other Fog Preventing Agent

Examples of other fog preventing agent include a mercury (II) salt described in JP-A No. 11-65021, paragraph number 0113, benzoic acids described in JP-A No. 11-65021, paragraph number 0114, a salicylic acid derivative described in JP-A No. 2000-206642, a formalin scavenger compound represented by the formula (S) described in JP-A No. 2000-221634, a triazine compound relating to claim 9 of JP-A No. 11-354624, a compound represented by the general formula (III) described in JP-A No. 6-11791, 4-hydroxy-6-methyl-1,3,3a, 7-tetrazinedene and the like.

For the purpose of fog prevention, the photothermographic material in the invention may contain an azolium salt. Examples of the azolium salt include a compound represented by the general formula (XI) described in JP-A No. 59-193447, a compound described in JP-B No. 55-12581, and a compound represented by the general formula (II) described in JP-A No. 60-153039. The azolium salt may be added to any part of a photosensitive material, and it is preferable to add to a layer of a plane having a photosensitive layer, and it is further preferable to add to an organic silver salt-containing layer. The azolium salt may be added at any step of preparation of a coating solution and, when added to an organic silver salt-containing layer, the salt may be added at any step from preparation of an organic silver salt to preparation of a coating solution, preferably after preparation of an organic silver salt to immediately before coating. The azolium salt may be added by any method such as a powder, a solution and a fine particle dispersion. In addition, a solution obtained by mixing with other additives such as a sensitizing dye, a reducing agent and a tone agent may be added. In the invention, an amount of the azolium salt to be added may be any amount, preferably not smaller than 1×10⁻⁶ mol and not larger than 2 mol, further preferably not smaller than 1×10⁻³ mol and not smaller than 0.5 mol.

Other Additives

1) Mercapto, Disulfide and Thiones

In the invention, for suppressing or promoting development, or controlling development, improving the Spectral sensitizing efficacy, or improving the shelf stability before and after development, a Mercapto, a disulfide compound and a thione compound may be contained, and examples thereof include compounds represented by the general formula (I) described in JP-A No. 10-62899, paragraph numbers 0067 to 0069, JP-A No. 10-186572, and embodiments thereof described in the same paragraph numbers 0033 to 0052, EP Publication No. 0803764A1, page 20, lines 36 to 56. Inter alia, mercapto-substituted heterocyclic aromatic compounds described in JP-A Nos. 9-297367, 9-304875, JP-A No. 2001-100358, Japanese Patent Application Nos. 2001-104213, and 2001-104214 are preferable.

2) Tone Agent

It is preferable that a tone agent is added to the photothermographic material of the invention, and a tone agent is described in JP-A No. 10-62899, paragraph numbers 0054 to 0055, EP Publication No. 0803764 A1, page 21, lines 23 to 48, JP-A Nos. 2000-356317 and 2000-187298 and, in particular, phthalazinones (phthalazinone, phthalazinone derivative or metal salt; e.g. 4-(1-naphthyl)phthalazinone, 6-chlorophthalazinone, 5,7-dimethoxyphthalazinone and 2,3-dihydro-1,4-phthalazinedione); a combination of phthalazinones and phthalic acids (e.g. phthalic acid, 4-methylphthalic acid, 4-nitrophthalic acid, diammonium phthalate, sodium phthalate, potassium phthalate and tetrachlorophthalic anhydride); phthaladines (phthaladine, phthaladine derivative or metal salt; e.g. 4-(1-naphthyl)phthalazine, 6-isopropylphthalazine, 6-t-butylphthalazine, 6-chlorophthalazine, 5,7-dimethoxyphthalazine and 2,3-dihydrophthalazine); a combination of phthalazines and phthalic acids are preferable, and a combination of phthalazine and phthalic acids is particularly preferable. Inter alia, a particularly preferable combination is a combination of 6-isopropylphthaladine and phthalic acid or 4-methylphthalic acid.

3) Plasticizer, Lubricant

A plasticizer and a lubricant which can be used in a photosensitive layer in the invention are described in JP-A No. 11-65021, paragraph number 0117, a Super-high contrast enhancer agent for forming a super-high contrast image and a method of adding the same and an amount of the agent are described in the same, paragraph number 0118, JP-A No. 11-223898, paragraph numbers 0136 to 0193, compounds of the formula (H), the formulae (1) to (3), the formulae (A) and (B) in JP-A No. 2000-284399, and compounds (specific compounds: Chemical formula 21 to Chemical formula 24) of the general formulae (III) to (V) described in Japanese Patent Application No. 11-91652, and a super-high contrast promoter is described in JP-A No. 11-65021, paragraph number 0102, and JP-A No. 11-223898, paragraph numbers 0194 to 0195.

4) Dyes and Pigments

From a viewpoint of improvement in tone, prevention of occurrence of interference fringe at laser exposure, and prevention of irradiation, various dyes and pigments (e.g. C. I. Pigment Blue 60, C. I. Pigment Blue 64, C. I. Pigment Blue 15:6) can be used in a photosensitive layer in the invention. These are described in WO98/36322, JP-A Nos. 10-268465, 11-338098 and the like in detail.

5) Super-High Contrast Enhancer Agent

For forming a super-high contrast image suitable for printing making plate utility, it is preferable to add a Super-high contrast enhancer agent to an image forming layer. A Super-high contrast enhancer agent and a method of adding the same and an amount of the same to be added are described in the same, paragraph number 0118, JP-A No. 11-223898, paragraph numbers 0136 to 0193, compounds of the formula (H), the formulae (1) to (3), and the formulae (A) and (B) in Japanese Patent Application No. 11-87297, compounds of the general formulae (specific compounds: Chemical formula 21 to Chemical formula 24) described in Japanese Patent Application No. 11-91652, and a super-high contrast promoter is described in JP-A No. 11-65021, paragraph number 0102, JP-A No. 11-223898, paragraph numbers 0194 to 0195.

In order to use formic acid or formate as a strong fogging substance, it is preferable that the substance is contained on a side having an image forming layer containing photosensitive silver halide at 5 mmol or smaller, further 1 mmol or smaller per 1 mol of silver.

When a Super-high contrast enhancer agent is used in the photothermographic material of the invention, it is preferable to jointly use an acid formed by hydration of diphosphorus pentaoxide, or a salt thereof. Examples of an acid formed by hydration of diphosphorus pentaoxide or a salt thereof include metaphosphoric acid (metaphosphate), pyrophosphoric acid (pyrophosphate), orthophophoric acid (orthophosphate), triphosphoric acid (triphosphate), tetraphosphoric acid (tetraphosphate) and hexametaphosphoric acid (hexametaphosphate). Examples of an acid formed by hydration of diphosphorus pentaoxide or a salt thereof which is particularly preferably used include orthophosphoric acid (orthophosphate) and hexametaphosphoric acid (hexamethaphosphate). Specific salts include sodium orthophosphate, dihydrogen sodium orthophosphate, sodium hexametaphosphate and ammonium hexametaphosphate.

An amount of an acid formed by hydration of diphosphorus pentaoxide or a salt thereof to be used (coating amount per 1 m² of photosensitive material) may be a desired amount depending on the performance such as the sensitivity and the fog, and 0.1 to 500 mg/m² is preferable, and 0.5 to 100 mg/m² is more preferable.

It is preferable to use a reducing agent, a hydrogen bond-forming compound, a development promoter and a polyhalogen compound in the invention as a solid dispersion, and a preferable process for preparing these solid dispersions is described in JP-A No. 2002-55405.

Preparation and Coating of Coating Solution

A preparation temperature of an image forming layer coating solution in the invention is suitably not lower than 30° C. and not higher than 65° C., a further preferable temperature is not lower than 35° C. and lower than 60° C., and a more preferable temperature is not lower than 35° C. and not higher than 55° C. In addition, it is preferable that a temperature of an image forming layer coating solution immediately after addition of a polymer latex is maintained at not lower than 30° C. and not higher than 65° C.

Layer Construction and Constituents

An image forming layer in the invention is constructed of one or more layer(s) on a substrate. When constructed of one layer, the layer comprises an organic silver salt, a photosensitive silver halide, a reducing agent and a binder and, if necessary, the layer contains desired additional materials such as a tone agent, a covering aid and other ancillary agents. When constructed of two or more layers, a first image forming layer (usually a layer adjacent to a substrate) must contain an organic silver salt and photosensitive silver halide, and a second image forming layer or both layers must contain some other components. A construction of a multi-color photosensitive thermal developing photographic material may contain a combination of these two layers per each color, or a single layer may contain all components as described in U.S. Pat. No. 4,708,928. In the case of a multi-dye multi-color photosensitive thermal developing photographic material, respective emulsion layers are generally distinguished from each other and are retained by using a functional or non-functional barrier layer between respective photosensitive layers as described in U.S. Pat. No. 4,460,681.

The photothermographic material of the invention can have a non-photosensitive layer in addition to an image forming layer. From arrangement, the non-photosensitive layer can be classified into (a) a surface protecting layer provided on an image forming layer (a side farer than a substrate), (b) an intermediate layer provided between a plurality of image forming layers, or between an image forming layer and a protecting layer, (c) an undercoat layer provided between an image forming layer and a substrate, and (d) a back layer provided on a side opposite to an image forming layer.

In addition, a layer acting as an optical filter may be provided, and is provided as a (a) or (b) layer. An anti-halation layer is provided as a (c) or (d) layer in a photosensitive material.

1) Surface Protecting Layer

In order to prevent adhesion of an image forming layer, a surface protecting layer can be provided on the photothermographic material in the invention. The surface protecting layer may be a single layer, or a plurality of layers.

The surface protecting layer is described in JP-A No. 11-65021, paragraph numbers 0119 to 0120, and JP-A No. 2000-171936.

As a binder in a surface protecting layer in the invention, gelatin is preferable, and it is also preferable to use polyvinyl alcohol (PVA) or use it jointly. As gelatin, inert gelatin (e.g. trade name: Nitta gelatin 750, manufactured by Nitta gelatin Co., Ltd.) and phthalated gelatin (e.g. trade name: Nitta gelatin 801, manufactured by Nitta gelatin Co., Ltd.) can be used. Examples of PVA include those described in JP-A No. 2000-171936, paragraph numbers 0009-2020, and preferable examples include completely saponified PVA-105, partially saponified PVA-205 and PVA-335, and MP-203 of modified polyvinyl alcohol (all trade names, manufactured by Kuraray Co., Ltd.). An amount of polyvinyl alcohol in a protecting layer (per 1 layer) to be coated (per 1 m² Of support) is preferably 0.3 to 4.0 g/m², more preferably 0.3 to 2.0 g/m².

An amount of a total binder (including water-soluble polymer and latex polymer) in a surface protecting layer (per 1 layer) to be coated (per 1 m² of support) is preferably 0.3 to 5.0 g/m², more preferably 0.3 to 2.0 g/m².

2) Anti-Halation Layer

In the photothermographic material of the invention, an anti-halation layer can be provided on a photosensitive layer on a side farer from a light source.

An anti-halation layer is described in JP-A No. 11-65021, paragraph numbers 0123 to 0124, JP-A Nos. 11-223898, 9-230531, 10-36695, 10-104779, 11-231457, 11-352625, 11-352626 and the like.

An anti-halation dye having absorption in an exposure wavelength is contained in an anti-halation layer. When an exposure wavelength is in an infrared region, an infrared-ray absorbing dye may be used and, in that case, a dye having no absorption in a visible region is preferable.

When halation prevention is conducted using a dye having absorption in a visible region, it is preferable that a color of a dye does not substantially remain after image formation, it is preferable that a means of quenching by the heat of thermal development is used, and it is particularly preferable that a thermal quenching dye and a base precursor are added to a non-photosensitive layer so as to function as an anti-halation layer. These techniques are described in JP-A No. 11-231457.

An amount of a quenching dye to be added is determined depending on utility of a dye. Generally, the dye is used at such an amount that the optical concentration (absorbance) when measured at a desired wavelength exceeds 0.1. The optical concentration is preferably 0.15 to 2, more preferably 0.2 to 1. An amount of a dye to be used for obtaining such the optical concentration is generally around 0.001 to 1 g/m².

When a dye is quenched like this, the optical concentration after thermal development can be lowered below 0.1. Two or more kinds of quenching dyes may be used jointly in a thermal quenching-type recording material or a photothermographic material. Similarly, two or more kinds of base precursors may be used jointly.

In thermal quenching using such the quenching dye and base precursor, it is preferable from the viewpoint of thermal quenching property that a substance which lowers a melting point by 3° C. (deg) or more when mixed with a base precursor described in JP-A No. 11-352626 (e.g. diphenylsulfone, 4-chlorophenyl(phenyl)sulfone), 2-naphthyl benzoate and the like are used jointly.

3) Back Layer

A back layer which can be applied to the invention is described in JP-A No. 11-65021, paragraph numbers 0128 to 0130.

In the invention, for the purpose of improving change in silver tone and image with time, a coloring agent having maximum absorption at 300 to 450 nm can be added. Such the agent is described in JP-A Nos. 62-210458, 63-104046, 63-103235, 63-208846, 63-306436, 63-314535, 01-61745, and 2001-100363.

Such the coloring agent is usually added in a range of 0.1 mg/m² to 1 g/m², and is preferably added to a back layer which is provided on a side opposite to a photosensitive layer.

In addition, in order to adjust base tone, it is preferable to use a dye having an absorption peak at 580 to 680 nm. As a dye for this purpose, an azomethine type oil-soluble dye having the small absorption intensity on a short wavelength side described in JP-A Nos. 4-359967 and 4-359968, and a phthalocyanine type water-soluble dye described in Japanese Patent Application No. 2002-96797 are preferable. A dye for this purpose may be added to any layer, and it is more preferable to add to a non-photosensitive layer on an emulsion surface side or to a back surface side.

It is preferable that the photothermographic material in the invention is a so-called one side photosensitive material having at least one photosensitive layer containing a silver halide emulsion on one side of a substrate, and having a back layer on the other side.

4) Matting Agent

In the invention, for improving the conveyance property, it is preferable to add a matting agent, and a matting agent is described in JP-A No. 11-65021, paragraph numbers 0126 to 0127. An amount of a matting agent to be coated per 1 m² of a photosensitive material is preferably 1 to 400 mg/m², more preferably 5 to 300 mg/m².

In the invention, a shape of a matting agent may be defined-shaped or undefined-shaped, and defined-shaped sphere is preferably used. An average particle diameter is preferably in a range of 0.5 to 10 μm, more preferably in a range of 1.0 to 8.0 μm, further preferably in a range of 2.0 to 6.0 μm. In addition, a variation coefficient of a size distribution is preferably 50% or smaller, more preferably 40% or smaller, further preferably 30% or smaller. Herein, a variation coefficient is a value expressed by (standard deviation of particle diameter)/(average of particle diameter)×100. In addition, it is preferable that two kinds of matting agents having a small variation coefficient and a ratio of an average particle diameter of larger than 3 are used jointly.

In addition, a matting degree of an emulsion surface may be any degree as far as stardust disorder does not occur, and is preferably not smaller than 30 seconds and not larger than 0.2000 seconds, particularly preferably not smaller than 40 seconds and not larger than 1500 seconds expressed as Beck smoothness. Beck smoothness can be easily obtained by the known method (e.g. Japanese Industry Standard (JIS) p.8119 “Method of testing smoothness of paper and board by Beck testing device”, TAPPI standard method T497 etc.).

In the invention, a matting degree of a back layer as a Beck smoothness is preferably not larger than 1200 seconds and not smaller than 10 seconds, more preferably not larger than 800 seconds and not smaller than 20 seconds, further preferably not larger than 500 seconds and not smaller than 40 seconds.

In the invention, it is preferable that a matting agent is contained in an outermost surface layer of a photosensitive material or a layer functioning as an outermost surface layer, or a layer near the outer surface, and it is preferable that the matting agent is contained in a layer acting as a so-called protecting layer.

5) Polymer Latex

When the photothermographic material of the invention is used in printing utility, in particular, in which a dimensional change is problematic, it is preferable that a polymer latex is used in a surface protecting layer or a back layer. Such the polymer latex is described in “Synthetic Resin Emulsion” (edited by Tira Okuda, Hiroshi Inagaki, published by Polymer Publishing society (1978)), “Application of Synthetic latex” (edited by Takaaki Sugimura, Yasuo Kataoka, Soichi Suzuki, Keiji Kasahara, published by Polymer Publishing Society (1993)) and “Chemistry of Synthetic Latex” (Authored Souichi Muroi, published by Polymer Publishing Society, (1970)), and examples thereof include methyl methacrylate (33.5% by weight); ethyl acrylate (50% by weight)/methacrylic acid (16.5% by weight) copolymer latex, methyl methacryalte (47.5% by weight)/butadiene (47.5% by weight)/itaconic acid (5% by weight) copolymer latex, ethyl acrylate/methacrylic acid copolymer latex, methyl methacrylate (58.9% by weight)/2-ethylhexyl acryalte (25.4% by weight)/styrene (8.6% by weight)/2-hydroxyethyl methacrylate (5.1% by weight)/acrylic acid (2.0% by weight) copolymer latex, methyl methacrylate (64.0% by weight)/styrene (9.0% by weight)/butyl acrylate (20.0% by weight)/2-hydroxyethyl methacryalte (5.0% by weight)/acrylic acid (2.0% by weight) copolymer latex. Further, as a binder for a surface protecting layer, a combination of polymer latexes described in Japanese Patent Application No. 11-6872, the techniques described in JP-A No. 2000-267226, paragraph numbers 0021 to 0025, the techniques described in Japanese Patent Application No. 11-6872, paragraph numbers 0027 to 0028, and the techniques described in JP-A No. 2000-19678, paragraph numbers 0023 to 0041 may be applied. A ratio of a polymer latex in a surface protecting layer is preferably not smaller than 10% by weight and not larger than 90% by weight, particularly preferably not smaller than 20% by weight and not larger than 80% by weight of a total binder.

6) Film Surface pH

In the photothermographic material of the invention, a film surface pH before thermal developing treatment is preferably 7.0 or smaller, more preferably 6.6 or smaller. A lower limit thereof is not particularly limited, but is around 3. A most preferable pH range is 4 to 6.2. It is preferable from the viewpoint of reduction in a film surface pH that a film surface pH is regulated by using an organic acid such as a phthalic derivative, a non-volatile acid such as sulfuric acid, or a volatile base such as ammonia. Since ammonia is easily volatized and can be removed before a coating step or thermal development, it is preferable in order to attain a low film surface pH.

Alternatively, it is preferable to use a non-volatile base such as sodium hydroxide, potassium hydroxide, lithium hydroxide and the like, and ammonia jointly. In addition, a method of measuring a film surface pH is described in JP-A No. 2000-284399, paragraph number 0123.

7) Hardening Agent

A hardening agent may be used in each layer of a photosensitive layer, a protecting layer and a back layer in the invention. As an example of a hardening agent, there are respective methods described in T. H. James “THE THEORY OF THE PHOTOGRAPHIC PROCESS, FOURTH EDITION” (published by Macmillan Publishing Co., Inc. in 1977), page 77 to 87, and in addition to chromium alum, 2,4-dichloro-6-hydroxy-s-triazine sodium salt, N,N-ethylenebis(vinylsulfonacetamide) and N,N-propylenebis(vinylsulfonacetamide), multi-valent metal ions described in the same document, page 78, polyisocyanates described in U.S. Pat. No. 4,281,060 and JP-A No. 6-208193, epoxy compounds described in U.S. Pat. No. 4,791,042, and vinylsulfone type compounds described in JP-A No. 62-89048 are preferably used.

A hardening agent is added as a solution, and a time of adding this solution to a protecting layer coating solution is from 180 minutes before coating to immediately before coating, preferably from 60 minutes before to 10 seconds before coating. A mixing method and mixing conditions are not particularly limited as far as the effect of the invention is sufficiently manifested. As a specific mixing method, there are a method of mixing in a tank so that an average retention time calculated from an addition flow rate and an amount of a solution to be supplied to a coater, and a method using a static mixer described in “Liquid Mixing Technology” authored by M. Harnby, M. F. Edwards, A. W. Nienow, translated by Koji TAKAHASHI (published by The Nikkan Kogyo Shimbun, Ltd. in 1989), Chapter 8.

8) Surfactant

Surfactants which can be applied in the invention are described in JP-A No. 11-65021, paragraph number 0132, solvents are described in the same, paragraph number 0133, supports are described in the same, paragraph number 0134, electrification prevention or electrical conducting layers are described in the same, paragraph number 0135, a method of obtaining a color image is described in the same, paragraph number 0136, and lubricants are described in JP-A No. 11-84573, paragraph numbers 0061 to 0064 and Japanese Patent Application No. 11-106881, paragraph numbers 0049 to 0062.

In the invention, it is preferable to use a fluorine type surfactant. Examples of a fluorine type surfactant include compounds described in JP-A Nos. 10-197985, 2000-19680, 2000-214554 and the like. In addition, a polymer fluorine type surfactant described in JP-A No. 9-281636 is also preferably used. In the photothermographic material of the invention, it is preferable to use fluorine type surfactants described in JP-A No. 2002-82411, Japanese Patent Application Nos. 2001-242357 and 2001-264110. In particular, fluorine type surfactants described in Japanese Patent Application Nos. 2001-242357 and No. 2001-2646110 are preferable in the electrification adjusting ability, the stability of a coating surface and the sliding property when a coating is prepared using an aqueous coating solution, and a fluorine type surfactant described in Japanese Patent Application No. 2001-264110 is most preferable in that the electrification adjusting ability is high and it is not necessary to use a large amount.

In the invention, a fluorine type surfactant may be used on either of an emulsion surface or a back surface, and it is preferable to use on both surfaces. In addition, it is particularly preferable to use by combining with the aforementioned electrically conductive layer containing a metal oxide. In this case, even when an amount of a fluorine type surfactant to be used on a surface having an electrically conductive layer is reduced or the surfactant is removed, the sufficient performance can be obtained.

A preferable amount of a fluorine type surfactant to be used is in a range of 0.1 mg/m² to 100 mg/m², more preferably in a range of 0.3 mg/m² to 30 mg/m², further preferably in a range of 1 mg/m² to 10 mg/m² on each of an emulsion surface and a back surface. In particular, a fluorine type surfactant described in Japanese Patent Application No. 2001-264110 has the remarkable effect, and a range of 0.01 to 10 mg/M² is preferable, and a range of 0.1 to 5 mg/M² is more preferable.

9) Antistatic Agent

It is preferable that the invention has an electrically conductive layer containing a metal oxide or an electrically conductive polymer. An antistatic layer may function also as an undercoating layer or a back layer surface protecting layer, or may be disposed separately. As an electrically conductive material in an antistatic layer, metal oxides in which oxygen defect or a heterogeneous metal atom is introduced in a metal oxide to enhance the electrical conductivity are preferably used. As an example of a metal oxide, ZnO, TiO₂ and SnO₂ are preferable. It is preferable to add Al or In to ZnO, add Sb, Nb, P, halogen element or the like to SnO₂, or add Nb, Ta or the like to TiO₂. In particular, SnO₂ with Sb added thereto is preferable. An amount of a heterogeneous atom to be added is preferably in a range of 0.01 to 30% by mol, more preferably in a range of 0.1 to 10% by mol. A shape of a metal oxide may be any of spherical, needle-like and plate-like. From a viewpoint of the effect of imparting the electrical conductivity, a needle-like particle having a ratio of a long axis/a short axis of 2.0 or larger, preferably 3.0 to 50 is suitable. An amount of a metal oxide to be used is preferably in a range of 1 mg/m² to 1000 mg/m², more preferably in a range of 10 mg/m² to 500 mg/m², more preferably in a range of 20 mg/m² to 200 mg/m². An antistatic layer in the invention may be disposed on any of an emulsion surface and a back surface, and it is preferable to dispose between a support and a back layer. Examples of an antistatic layer in the invention are described in JP-A No. 11-65021, paragraph number 0135, JP-A Nos. 56-143430, 56-143431, 58-62646, 56-120519, 11-84573, paragraph numbers 0040 to 0051, U.S. Pat. No. 5,575,957, and JP-A No. 11-223898, paragraph numbers 0078 to 0084.

10) Support

In order to alleviate the internal distortion remaining in a film at biaxial stretching and exclude thermal shrinkage distortion generated during thermal developing treatment, as a transparent support, polyester, in particular, polyethylene terephthalate which has been subjected to heat treatment at a temperature range of 130 to 185° C. is preferably used. In the medical photothermographic material, a transparent support may be colored with a blue dye (e.g. dye-1 described in JP-A No. 8-240877, Example) or non-colored. It is preferable to apply the technique of undercoating water-soluble polyester described in JP-A No. 11-84574, a styrene butadiene copolymer described in same 10-186565, or a vinylidene chloride copolymer described in JP-A No. 2000-39684 and Japanese Patent Application No. 11-106881, paragraph numbers 0063 to 0080 to a support.

11) Other Additives

Further, an antioxidant, a stabilizer, a plasticizer, an ultraviolet-ray absorbing agent or a covering aid may be added to the photothermographic material. Various additives are added to either of a photosensitive layer or a non-photosensitive layer. Regarding them, reference may be made to WO98/36322, EP803764A1, JP-A Nos. 10-186567, and 10-18568.

12) Coating Format

The photothermographic material in the invention may be coated by any method. Specifically, various coating procedures including extrusion coating, slide coating, curtain coating, dipping coating, knife coating, flow coating, and extrusion coating using a hopper described in U.S. Pat. No. 2,681, 294 are used, extrusion coating and slide coating described in Stephen F. Kistler, Petert M. Schweizer “LIQUID FILM COATING” (published by CHAPMAN & HALL in 1997), page 399 to 536 are preferably used, and slide coating is particularly preferably used. An example of a shape of a slide coater used in slide coating is described in the same document, page 427, FIG. 11b.1. Alternatively, two or more layers can be coated at the same time, if necessary, by a method described in the same document, page 399 to 536, or a method described in U.S. Pat. No. 2,761,791 and British Patent No. 837,095. A particularly preferable coating method in the invention is a method described in JP-A Nos. 2001-194748, 2002-153808, 2002-153803, 2002-182333.

It is preferable that an organic silver salt-containing layer coating solution in the invention is a so-called thixiotropic fluid. Regarding this technique, reference can be made to JP-A No. 11-52509. The organic silver salt-containing layer coating solution in the invention has a viscosity at a shear rate of 0.1 S⁻¹ of, preferably not smaller than 400 mPa·s and not larger than 100,000 mPa·s, more preferably not smaller than 500 mPa·s and not larger than 20,000 mPa·s. In addition, at a shear rate of 1000 S⁻¹, a viscosity is preferably not smaller than 1 mPa·s and not larger than 200 mPa·s, Further preferably not smaller than 5 mPa·s and not larger than 80 mPa·s.

When two kinds of solutions are mixed in preparing a coating solution in the invention, the known in-line mixer and implant mixer are preferably used. A preferable in-line mixer in the invention is described in JP-A No. 2002-85948, and an implant mixer is described in JP-A No. 2002-96940.

It is preferable that a coating solution in the invention is defoaming-treated in order to retain the state of a coating surface better. A defoaming treating method preferable in the invention is a method described in JP-A No. 2002-66431.

Upon coating of a coating solution in the invention, it is preferable to eliminate electricity in order to prevent adhesion of a rubbish and a dust due to electrification of a support. An example of a method of eliminating electricity preferable in the invention is described in JP-A No. 2002-143747.

In the invention, it is important to precisely control a drying wind and a drying temperature in order to dry a non-setting image forming layer coating solution. A drying method preferable in the invention is described in detail in JP-A Nos. 2001-194749, and 2002-139814.

It is preferable that the photothermographic material of the invention is heat-treated immediately after coating and drying in order to improve the film foaming property. A temperature of heat treatment as a film surface temperature is preferably in a range of 60° C. to 100° C., and a heating time is preferably in a range of 1 second to 60 seconds. A more preferable range is a film surface temperature of 70 to 90° C. and a heating time of 2 to 10 seconds. A method of heat treatment preferable in the invention is described in JP-A No. 2002-107872.

In addition, in order to continuously prepare the photothermographic material of the invention stably, a process described in JP-A Nos. 2002-156728, and 2002-182333 is preferably used.

It is preferable that the photothermographic material is a monosheet-type (a type which can form an image on a photothermographic material without using other sheet as in an image receiving material).

13) Packaging Material

It is preferable that the photosensitive material of the invention is wrapped with a packaging material having the low oxygen permeability and/or moisture permeability in order to suppress variation of the photographic property at live storage, or improve curling and winding habit. The oxygen permeability is preferably 50 ml/atm·m²·day or smaller, more preferable 10 ml/atm·m²·day or smaller, further preferably 1.0 ml/atm·m²·day or smaller, at 25° C. The moisture permeability is preferably 10 g/atm·m²·day or smaller, more preferably 5 g/atm·m²·day or smaller, further preferable 1 g/atm·m²·day or smaller.

Examples of a packaging material having the low oxygen permeability and/or moisture permeability include packaging materials described in JP-A Nos. 8-254793 and 2000-206653.

14) Other Available Techniques

The techniques which can be used in the thermal photosensitive material of the invention include those described in EP Nos. 803764A1, 883022A1, WO98/36322, JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001,10-207004, 10-221807, 10-282601, 10-288823, 10-288824,10-307365, 10-312038, 10-339934, 11-7100, 11-15105, 11-24200, 11-24201, 11-30382, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2000-187298, 2000-10229, 2000-47345, 2000-206642, 2000-98530,2000-98531, 2000-112059, 2000-112060, 2000-112104, 2000-112064, and 2000-171936.

In the case of a multi-color photothermographic material, respective emulsion layers are generally retained by being isolated from each other by using a functional or non-functional barrier layer between respective photosensitive layers as described in U.S. Pat. No. 4,460,681.

The construction in the case of a multi-color photothermographic material may contain a combination of these two layers regarding each color, or may contain all components in a single layer as described in U.S. Pat. No. 4,708,928.

Image Forming Method

1) Exposure

Red to infrared emitting He—Ne laser, red semiconductor laser, blue to green emitting Ar⁺, He—Ne, He—Cd laser, and blue semiconductor laser. A red to infrared semiconductor laser is preferable, and a peak wavelength of the laser light is 600 nm to 900 nm, preferably 620 nm to 850 nm. In contrast to the above, recently, in particular, a module in which a SHG (Second Harmonic Generator) element and a semiconductor laser are incorporated, and a blue semiconductor laser have been developed, and a laser output apparatus at a short wavelength region has been paid attention. Demand of a blue semiconductor laser is expected to be expanded in the future because a high precision image recording is possible, a recording density is increased, and a long and stable output can be obtained. A peak wavelength of a blue laser light is 300 nm to 500 nm, particularly preferably 400 nm to 500 nm.

It is preferable that the laser light is oscillated in a longitudinal multiple format by a high frequency overlapping.

2) Thermal Development

The photothermographic material of the invention may be developed by any method, and is usually developed by raising a temperature of a photothermographic material exposed to an image wide. A preferable developing temperature is 80 to 250° C., preferably 100 to 140° C., more preferably 110 to 130° C. A developing time is preferably in a range of 1 to 60 seconds, more preferably 3 to 30 seconds, further preferably 5 to 25 seconds, particularly preferably within 16 seconds, such as in a range of 7 to 15 seconds.

As a format of thermal development, any of a drum-type heater and a plate-type heater may be used, and a plate-type heater format is more preferable. As a thermal development format according to a plate-type heater format, a method described in JP-A No. 11-133572 is preferable, and it is a thermal developing apparatus for obtaining a visible image by contacting a photothermographic material with a latent image formed thereon with a heating means at a thermal developing part, in which the heating means is composed of a plate heater, a plurality of pushing rollers are oppositely disposed along one surface of the plate heater, and thermal development is performed by passing the photothermographic material between the pushing roller and the plate heater. It is preferable that the plate heater is divided into 2 to 6 stages and a temperature is lowered by around 1 to 10° C. at a tip part. For example, there is an example in which four sets of plate heaters which can control a temperature independently are used, so as to control at 112° C., 119° C., 121° C., 120° C., respectively. Such the method is described in JP-A No. 54-30032, in which a moisture and an organic solvent contained in a photothermographic material can be excluded to the outside of a system, and change in a shape of a support for the photothermographic material due to rapid heating of the photothermographic material can be suppressed.

In order to miniaturize and shorten a thermal developing time, it is preferable that more stable control of a heater can be conducted, and it is desirable to initiate exposure of one sheet photosensitive material at its tip, and initiate thermal development before completion of exposure until a rear part. An imager being capable of conducting rapid treatment which is preferable in the invention is described, for example, in Japanese Patent Application Nos. 2001-08832 and 2001-091114. When this imager is used, it is possible to conduct thermal developing treatment for 14 seconds, for example, with a three-stage plate-type heater controlled at 107° C.-121° C.-121° C., and an output time for the first sheet can be shortened to about 60 seconds. For such the rapid thermal developing treatment, it is preferable to use by combining with the thermal developing material-2 in the invention which hardly undergoes influence of an environmental temperature.

3) System

Examples of a medical laser imager equipped with an exposing part and a thermal developing part include Fuji Medical dry laser imager FM-DP L. FM-DP L is described in Fuji Medical Review No. 8, page 39 to 55, and it goes without saying that those techniques can be applied as a laser imager for the photothermographic material of the invention. Alternatively, as a network system suitable for DICOM, “AD network” laser imager proposed by Fuji Film Medical System Co., Ltd. can be applied to a photothermographic material.

Utility of the Invention

It is preferable that the photothermographic material is used as a medical diagnostic photothermographic material, an industrial photographic photothermographic material, a printing photothermographic material, or a COM photothermographic material, after formation of a black and white image due to silver image.

### EXAMPLES

The present invention will be specifically explained by way of Examples below, but the invention is not limited by them. Fundamental construction of photothermographic material

Preparation of PET Support

Using terephthalic acid and ethylene glycol, PET having an intrinsic viscosity IV=0.66 (measured in phenol/tetrachloroethane=6/4 (weight ratio) at 25° C.) is obtained. This was pelletized, dried at 130° C. for 4 hours, melted at 300° C., extruded through a T die, and cooled to make an unstretched film having such a thickness that a thickness after thermal setting became 175 μm.

This was stretched at 3.3-fold in a machine direction using rolls having different circumferential rates and, then, stretched at 4.5-fold in a transverse direction with a tenter. Temperatures thereupon are 110° C. and 130° C., respectively. Thereafter, this was thermally set at 240° C. for 20 seconds, and relaxed by 4% in a transverse direction at the same temperature. Thereafter, a chuck part of the tenter was subjected to slitting, both ends are subjected to Narr processing, and wound at 4 kg/cm² to obtain a roll having a thickness of 175 μm.

Surface Corona Treatment

Using a corona treating machine (trade name: Solid State corona treating machine 6 KVA model, manufactured by Pillar), both surfaces of a support are treated at room temperature at 20 m/min. From readings of a current and a voltage upon this, it was found that a support is treated at 0.375 kV·A·min/m². Upon this, a treating frequency was 9.6 kHz, and a gap clearance between an electrode and a dielectric roll was 1.6 mm.

Preparation of undercoated support
(1) Preparation of undercoating layer coating solution
Formulation 1 (for photosensitive layer side undercoating)

| | | |
|---|---|---|
| Polyester resin (trade name: paste resin A-520 (30% by weight | 59 | g |
| solution), manufactured by Takamatsu Oil & Fat Co., Ltd.) | | |
| Polyethylene glycol monononyl phenyl ether (Average | 5.4 | g |
| ethylene oxide number = 8.5) 10% by weight solution | | |
| Polymer fine particle (trade name: MP-1000, manufactured by | 0.91 | g |
| Soken Chemical & Engineering Co., Ltd.) | | |
| Distilled water | 935 | ml |

Formulation 2 (for back surface first layer)

| | | |
|---|---|---|
| Styrene-butadiene copolymer latex | 158 | g |
| (Solid 40% by weight, styrene/butadiene weight ratio = 68/32) | | |
| 2,4-Dichloro-6-hydroxy-s-triazine sodium salt (8% by weight | 20 | g |
| aqueous solution) | | |
| 1% by weight aqueous solution of sodium | 10 | ml |
| laurylbenzenesulfonate | | |
| Distilled water | 854 | ml |

Formulation 3 (for back surface side second layer)

| | | |
|---|---|---|
| SnO₂/SbO (9/1 mass ratio, average particle diameter: | 84 | g |
| 0.038 μm, 17% by weight dispersion) | | |
| Gelatin (10% by weight aqueous solution) | 89.2 | g |
| Cellulose derivative (trade name: Methorose TC-5, | 8.6 | g |
| manufactured by Shin-Etsu Chemical Co., Ltd.) (2% by | | |
| weight aqueous solution) | | |
| Polymer fine particle (trade name: MP-1000, manufactured by | 0.01 | g |
| Soken Chemical & Engineering Co., Ltd., average particle | | |
| diameter 0.4 μm) | | |
| 1 weight % aqueous solution of sodium | 10 | ml |
| dodecylbenzenesulfonate | | |
| NaOH (1% by weight) | 6 | ml |
| Proxel (manufactured by ICI) | 1 | ml |
| Distilled water | 805 | ml |

Each of both sides of the aforementioned biaxial stretched polyethylene terephthalate support having a thickness of 175 μm was subjected to the aforementioned corona discharge treatment, (1) the aforementioned undercoating coating solution formation was coated on one side (photosensitive layer side) at a wet coating amount of 6.6 ml/m² (per one side) with a wire bar, and dried at 180° C. for 5 minutes and, then, (2) the aforementioned undercoating coating solution formulation was coated on a back side at a wet coating amount of 5.7 ml/m² with a wire bar, and dried at 180° C. for 5 minutes, further, (3) the aforementioned undercoating coating solution formulation was coated on the back side at a wet coating amount of 7.7 ml/m² with a wire bar, and dried at 180° C. for 6 minutes to prepare an undercoated support.

Preparation of Back Coating Solution

Preparation of (a) Solid Fine Particle Dispersion of Base Precursor

2.5 kg of the base precursor compound-1, 300 g of a surfactant (trade name: Demol N, manufactured by Kao Corporation), 800 g of diphenylsulfone, 1.0 g of benzoisothiazolinone sodium salt and distilled water were mixed to a total amount of 8.0 kg, and the mixed solution was beads-dispersed using a transverse-type sand mill (trade name: UVM-2, manufactured by AIMEX). As a dispersing method, the mixed solution was fed to UVM-2 charged with zirconia beads having an average diameter of 0.5 mm with a diaphragm pomp, and dispersed in the state at an internal pressure of 50 hPa or higher until a desired average particle diameter was obtained.

The dispersion was dispersed until a ratio of absorbance at 450 nm and absorbance at 650 nm (D450/D650) in spectral absorption of the dispersion as determined by spectral absorption measurement became 3.0. The resulting dispersion was diluted with distilled water so that the concentration of a base precursor became 25% by weight, and filtered with a filter (average pore diameter: using a 3 μm polypropylene filter) in order to trash, which was put into practice.

Preparation of Dye Solid Fine Particle Dispersion

6.0 kg of the cyanine dye compound-1, 3.0 kg of sodium p-dodecylbenzenesulfonate, 0.6 kg of a surfactant (trade name: Denol SNB, manufactured by Kao Corporation) and 0.15 kg of a defoaming agent (trade name: Saffinol 104E, manufactured by Nisshin Chemicals Co., Ltd.) were mixed with distilled water to a total solution amount of 60 kg. The mixed solution was dispersed with 0.5 mm zirconia beads using a transverse-type sand mill (trade name: UVM-2, manufactured by AIMEX).

The dispersion was dispersed until a ratio of absorbance at 650 nm and absorbance at 750 nm (D650/D750) in spectral absorption of the dispersion as determined by spectral absorption measurement became 5.0 or larger. The resulting dispersion was diluted with distilled water so that the concentration of a cyanine dye became 6% by weight, and filtered with a filter (average pore diameter, 1 μm) to remove trash, which was put into practice.

Preparation of Halation Preventing Layer Coating Solution

A temperature of a container was retained at 40° C., and 40 g of gelatin, 20 g of monodisperse polymethyl methacrylate fine particle (average particle size 8 μm, particle diameter standard deviation 0.4), 0.1 g of benzoisothiazolinone and 490 ml of water were added to dissolve gelatin. Further, 2.3 ml of a 1 mol/l aqueous sodium hydroxide solution, 40 g of the aforementioned dye solid fine particle dispersion, 90 g of (a) the aforementioned solid fine particle dispersion of a base precursor, 12 ml of a 3% aqueous sodium polystyrene sulfonate solution and 180 g of a 10% SBR latex solution were mixed. Immediately before coating, 80 ml of a 4% aqueous N,N-ethylenebis(vinylsulfoneacetamide) solution was mixed therein to obtain a halation preventing layer coating solution.

Preparation of Back Surface Protecting Layer Coating Solution

A temperature of a container was retained at 40° C., and 40 g of gelatin, 35 mg of benzoisothiazolinone and 840 ml of water were added to dissolve gelatin. Further, 5.8 ml of a 1 mol/l aqueous sodium hydroxide solution, 1.5 g of liquid paraffin emulsion as liquid paraffin, 10 ml of a 5% aqueous di(2-ethylhexyl) sulfosuccinate sodium salt solution, 20 ml of a 3% aqueous sodium polystyrene sulfonate solution, 2.4 ml of a 2% fluorine type surfactant (F-1) solution, 2.4 ml of a 2% fluorine type surfactant (F-2) solution, and 32 g of a 19% by weight methyl methacrylate/sutyrene/butyl acrylate/hydroxyethyl methacrylate/acrylic acid copolymer (copolymerization ratio 57/8/28/5/2) latex solution were mixed. Immediately before coating, 25 ml of 4% aqueous N, N-ethylenebis (vinylsulfoneacetamide) solution was mixed therein to obtain a back surface protecting layer coating solution.

Preparation of Silver Halide Emulsion

Preparation of Silver Halide Emulsion 1

3.1 ml of a 1% by weight potassium bromide solution was added to 1421 ml of distilled water, and 3.5 ml of sulfuric acid having the concentration of 0.5 mol/l and 31.7 g of phthalated gelatin were added to obtain a solution, a temperature of which was retained at 30° C. while stirring in a reaction pot, and a solution A obtained by diluting to 22.22 g of silver nitrate to 95.4 ml by adding distilled water and a solution B obtained by diluting 15.3 g of potassium bromide and 0.8 g of potassium iodide to a volume of 97.4 ml with distilled water were added at a total amount at a constant flow rate over 45 seconds. Thereafter, 10 ml of a 3.5% by weight aqueous hydrogen peroxide solution was added, and 10.8 ml of 10% by weight aqueous benzoimidazole solution was further added. Further, a solution C obtained by diluting 51.86 g of silver nitrate to 317.5 ml by adding distilled water and a solution D obtained by diluting 44.2 g of potassium bromide and 2.2 g of potassium iodide to a volume of 400 ml with distilled water were added at a total amount at a constant flow rate over 20 minutes in the case of the solution C, or by a controlled double jet method while maintaining a pAg at 8.1 in the case of the solution D.

A total amount of a potassium salt of iridate (III) hexachloride was added to 1×10⁻⁴ mol per 1 mol of silver 10 minutes after initiation of addition of the solution C and the solution D. In addition, a total amount of an aqueous potassium hexacyanoferrate (II) solution was added at 3×10⁻⁴ mol per 1 mol of silver 5 seconds after completion of addition of the solution C. pH thereof was adjusted to 3.8 using sulfuric acid having the concentration of 0.5 mol/L, stirring was stopped, and a precipitation/desalting/water washing step was performed. pH thereof was adjusted to 5.9 using sodium hydroxide having the concentration of 1 mol/L to prepare a silver halide dispersion having a pAg of 8.0.

A temperature of the aforementioned silver halide dispersion was maintained at 38° C. while stirring, 5 ml of a 0.34% by weight solution of 1,2-benzoisothiazolin-3-one in methanol and, 40 minutes after, a temperature was elevated to 47° C. After 20 minutes from temperature elevation, a solution of sodium benzenethiosulfonate in methanol was added at 7.6×10⁻⁵ mol per 1 mol of silver and, further, after 5 minutes, a solution of a tellurium sensitizing agent C in methanol was added at 2.9×10⁻⁴ mol per 1 mol of silver, followed by aging for 91 minutes. Thereafter, a solution of a Spectral sensitizing pigment A and a sensitizing pigment B at a molar ratio of 3:1 in methanol was added at a total of sensitizing pigments A and B of 1.2×10⁻³ mol per 1 mol of silver and, after 1 minute, 1.3 ml of a 0.8% by weight solution of N,N′-dihydroxy-N″-diethylmelamine in methanol was added and, further 4 minutes after, a solution of 5-methyl-2-mercaptobenzoimidazole in methanol at 4.8×10⁻³ mol per 1 mol of silver, a solution of 1-phenyl-2-heptyl-5-mercapto-1,3,4-triazole in methanol at 5.4×10⁻³ mol per 1 mol of silver and an aqueous solution of 1-(3-methylureido)-5-mercaptotetrazole sodium salt at 8.5×10⁻³ mol per 1 mol of silver were added to prepare a silver halide emulsion 1.

A particle in the prepared silver halide emulsion was a silver bromide iodide particle containing 3.5% by mol iodine uniformly and having an average sphere-equivalent diameter of 0.042 μm and a variation coefficient of a sphere-equivalent diameter of 20%. A particle size and the like were obtained from an average of 1000 particles using an electron microscope. A [100] plane ratio of this particle was obtained to be 80% using a Kuberkamunk method.

Preparation of Silver Halide Emulsion 2

According to the same manner as that of preparation of the silver halide emulsion 1 except that a solution temperature at particle formation was changed from 30° C. to 47° C., 15.9 g of potassium bromide was diluted with distilled water to a volume of 97.4 ml in the solution B, 45.8 g of potassium bromide was diluted with distilled water to a volume of 400 ml in the solution D, a time of adding the solution C was 30 minutes, and potassium hexacyanoferrete (II) aws removed, a silver halide emulsion 2 was prepared. Preparation/desalting/water washing/dispersion were performed as in the silver halide emulsion 1. Further, according to the same manner as that of the emulsion 1 except that an amount of a tellurium sensitizing agent C to be added was changed to 1.1×10⁻⁴ mol per 1 mol of silver, an amount of a solution of a Spectral sensitizing pigment A and a Spectral sensitizing pigment B at a molar ratio of 3:1 in methanol to be added was changed to a total of the sensitizing pigment A and the sensitizing pigment B per 1 mol of silver of 7.0×10⁻⁴ mol, 1-phenyl2-heptyl-5-mercapto-1,3,4-triazole was changed to 3.3×10⁻³ mol per 1 mol of silver, and 1-(3-methylureido)-5-mercaptotetrazole sodium salt was changed to 4.7×10⁻³ mol per 1 mol of silver, chemical sensitization, and addition of 5-methyl-2-mercaptobenzoimidazole and 1-phenyl-2-heptyl-5-mercapto-1,3,4-triazole were performed to obtain a silver halide emulsion 2. An emulsion particle of the silver halide emulsion 2 was a pure silver bromide cubic particle having an average sphere-equivalent diameter of 0.080 μm and a variation coefficient of a sphere-equivalent diameter of 20%.

Preparation of Silver Halide Emulsion 3

According to the same manner as that of preparation of the silver halide emulsion 1 except that a solution temperature at particle formation was changed from 30° C. to 27° C., a silver halide emulsion 3 was prepared. In addition, precipitation/desalting/water washing/dispersion were performed as in the silver halide emulsion 1. According to the same manner as that of the emulsion 1, except that an amount of a Spectral sensitizing pigment A and a Spectral sensitizing pigment B at a molar ratio of 1:1 as a solid dispersion (aqueous gelatin solution) to be added was changed to a total of a sensitizing pigment A and a sensitizing pigment B of 6×10⁻³ mol per 1 mol of silver, an amount of a tellurium sensitizing agent C to be added was changed to 5.2×10⁴ mol per 1 mol of silver and, 3 minutes after addition of the tellurium sensitizing agent, aurate bromide was added at 5×10⁻⁴ mol per 1 mol of silver and potassium thiocyanate was added at 2×10⁻³ mol per 1 mol of silver, a silver halide emulsion 3 was obtained. An emulsion particle of the silver halide emulsion 3 was a silver bromide iodide particle containing 3.5% by mol of iodine uniformly and having an average sphere-equivalent diameter of 0.034 μm and a variation coefficient of a sphere-equivalent diameter of 20%.

Preparation of Mixed Emulsion A for Coating Solution

70% by weight of the silver halide emulsion 1, 15% by weight of the silver halide emulsion 2 and 15% by weight of the silver halide emulsion 3 were dissolved, and a 1% by weight aqueous benzothiazolium iodide solution was added at 7×10⁻³ mol per 1 mol of silver. Further, water was added so that the content of silver halide per 1 kg of a mixed emulsion for coating solution became 38.2 g as silver, and a sodium salt of 1-(3-methylurado)-5-mercaptotetrazole was added at 0.34 g per 1 kg of a mixed emulsion for coating solution.

Preparation of Fatty Acid Silver Dispersion A

87.6 kg of behenic acid (trade name: Edenor C22-85R, manufactured by Henkel), 423 L of distilled water, 49.2 L of an aqueous NaOH solution having the concentration of 5 mol/L, and 120 L of t-butyl alcohol were mixed, and stirred to react at 75° C. for 1 hour to obtain a sodium behenate solution A. Separately, 206.2 L of an aqueous solution of 40.4 kg of silver nitrate (pH 4.0) was prepared, and a temperature was retained at 10° C. A temperature of a reaction vessel in which 635 L of distilled water and 30 L of t-butyl alcohol were placed was retained at 30° C., and a total amount of the aforementioned sodium behenate solution A and a total amount of the silver nitrate solution were added at a constant flow rate over 93 minutes and 15 seconds and 90 minutes, respectively, while stirring well. Upon this, for 11 minutes after initiation of addition of the aqueous silver nitrate solution, only the aqueous silver nitrate solution was added and, thereafter, addition of the sodium behenate solution A was initiated and, for 14 minutes and 15 seconds after completion of addition of the aqueous silver nitrate solution, only the sodium behenate solution A was added. Upon this, a temperature in the reaction vessel was 30° C., and an outer temperature was controlled so that a solution temperature became constant. In addition, a temperature of a piping of a system for adding the sodium behenate solution A was retained by circulating warm water outside a double tube, and the system was regulated so that a solution temperature of an exit at a tip of an addition nozzle became 75° C. In addition, a temperature of a piping of a system for adding the aqueous silver nitrate solution was retained by circulating cold water outside a double tube. A position of adding the sodium behenate solution A and a position of adding the aqueous silver nitrate solution were disposed symmetrically relative to a stirring axis as a center, and heights were regulated so as not to contact with a reaction solution.

After completion of addition of the sodium behenate solution A, the solution was allowed to stand while stirring at that temperature for 20 minutes, and a temperature was raised to 35° C. over 30 minutes, followed by aging for 210 minutes. Immediately after completion of aging, solids were filtered off by centrifugation filtration, and the solids were washed with water until the conductivity of filtering water became 30 μS/cm. Thus, fatty acid silver salt was obtained. The resulting solids were stored as a wet cake without drying.

The form of the resulting silver behenate particle was evaluated by electron microscope imaging, and the particle was a scale-like crystal having, as an average, a =0.14 μm, b=0.4 μm, c=0.6 μm, an average aspect ratio of 5.2, an average sphere-equivalent diameter of 0.52 μm, and a variation coefficient of a sphere-equivalent diameter of 15% (a, b and c were defined in the text).

19.3 kg of polyvinyl alcohol (trade name: PVA-217, manufactured by Kurarey Co., Ltd.) and water were added to the wet cake corresponding to 260 kg of dry solid, a total weight of 1000 kg, the material is slurried with a dissolver wing, and further pre-dispersed with a pipeline mixer (trade name: PM-10 type, manufactured by MIZUHO Industrial Co., Ltd.).

Then, the pre-dispersed stock solution was treated three time with a dispersing machine (trade name: Microfluidizer M-610, manufactured by Microfluidex International Corporation, using Z-type interaction chamber) by regulating a pressure at 1260 kg/cm², to obtain a silver behenate dispersion. Cooling procedures were as follows: each of hose heat exchangers was mounted before and after the interaction chamber, and a temperature was set at a dispersion temperature at 18° C. by regulating a temperature of cooing medium.

Preparation of Fatty Acid Silver Dispersion B

Preparation of Recrystallized Behenic Acid

100 kg of behenic acid (trade name: Edelor C22-85R, manufactured by Henkel) was mixed with 1200 kg of isopropyl alcohol, dissolved at 50° C., filtered with a 10 μm filter, and recrystallization was performed by cooling to 30° C. A cooling speed upon recrystallization was controlled at 3° C./hour. The resulting crystal was filtered by centrifugation, and washed with 100 kg of isopropyl alcohol, and dried. The resulting crystal was esterified, subjected to GC-FID measurement, and it was found that the content of behenic acid is 96% and, besides, 2% of lignoceric acid, 2% of arachidic acid and 0.001% of erucic acid are contained.

Preparation of Fatty Acid Silver Dispersion B

88 kg of recrystallized behenic acid, 422 L of distilled water, 49.2 L of an aqueous NaOH solution having the concentration of 5 mol/L and 120 L of t-butyl alcohol were mixed, and stirred at 75° C. for 1 hour to react, to obtain sodium behenate solution B. Separately, 260.2 L of an aqueous solution of 40.4 kg of silver nitrate (pH 4.0) was prepared, and a temperature of the solution was retained at 10° C. A temperature of a reaction vessel in which 635 L of distilled water and 30 L of t-butyl alcohol were placed was retained at 30° C., and a total amount of the sodium behenate solution B and a total amount of the aqueous silver nitrate solution were added at a constant flow rate over 93 minutes and 15 seconds and 90 minutes, respectively, while stirring well. Upon this, for 11 minutes after initiation of addition of the aqueous silver nitrate solution, only the aqueous silver nitrate solution was added and, thereafter, addition of the sodium behenate solution B was initiated and, for 14 minutes and 15 seconds after completion of addition of the aqueous nitrate solution, only the sodium behenate solution B was added. Upon this, a temperature in the reaction vessel was 30° C., and an external temperature was controlled so that a solution temperature became constant. In addition, a temperature of a piping of a system for adding the sodium behenate solution B was retained by circulating warm water outside a double tube, and a solution temperature of an exit at a tip of an addition nozzle was regulated at 75° C. In addition, a temperature of a piping of a system for adding the aqueous silver nitrate solution was retained by circulating cold water outside a double tube. A position of adding the sodium behenate solution B and a position of adding the aqueous silver nitrate solution were disposed symmetrically relative to a stirring axis as a center, and heights are regulated so as not to contact with a reaction solution.

After completion of addition of the sodium behenate solution B, the solution was allowed at that temperature for 20 minutes while stirring, and a temperature was elevated to 35° C. for 30 minutes, followed by aging for 210 minutes. Immediately after completion of aging, the solid was filtered off by centrifugation filtration, and the solid was washed with water until the conductivity of filtering water became 30 μS/cm. Thus, fatty acid silver salt was obtained. The resulting solid was stored as a wet cake without drying.

The form of the resulting silver behenate particle was evaluated with electron microscope imaging, and a crystal was found to have, as an average, a=0.21 μm, b=0.4 μm, c=0.4 μm, average aspect ratio of 2.1, and a variation coefficient of a sphere-equivalent diameter of 11% (a, b and c were defined in the text).

19.3 kg of polyvinyl alcohol (trade name: PVA-217, manufactured by Kurarey Co., Ltd.) and water were added to the wet cake corresponding to 260 kg of the dry solid, to a total amount of 1000 kg, the material was slurried with a dissolver wing, and further pre-dispersed with a pipeline mixer (manufactured by MIZUHO Industrial Co., Ltd.: PM-10 type).

Then, the pre-dispersed stock solution was treated three times with a dispersing machine (trade name: Microfluidizer M-610, manufactured by Microfluidex International Corporation, using Z-type interaction chamber) by regulating a pressure at 1150 kg/cm², to obtain the silver behenate dispersion. The cooling procedures were as follows: each of hose heat exchangers was mounted before and after the interaction chamber, and a dispersion temperature was set at 18° C. by regulating a temperature of a cooling medium.

Preparation of Reducing Dispersion

Preparation of Reducing Agent-1 Dispersion

10 kg of water was added to 10 kg of the reducing agent-1 (2,2′-methylenebis(4-ethyl-6-tert-butylphenol)) and 16 kg of a 10% by weight aqueous solution of denatured polyvinyl alcohol (trade name: POVAR MP203, manufactured by Kuraray Co., Ltd.), and mixed well to obtain a slurry. This slurry was fed with a diaphragm, dispersed for 3 hours with a transverse-type sand mill (trade name: UVM-2, manufactured by AIMEX) charged with zirconia beads having an average diameter of 0.5 mm, and 0.2 g of a sodium salt of benzoisothiazolinone and water were added to adjust the concentration of a reducing agent to 25% by weight. This dispersion was heat-treated at 60° C. for 5 hours to obtain a dispersion of the reducing agent-1. A reducing agent particle contained in the thus obtained reducing agent dispersion had a median diameter of 0.40 μm and a maximum particle diameter of 1.4 μm or smaller. The resulting reducing agent dispersion was filtered with a polypropylene filter having a pore diameter of 3.0 μm, to remove foreign matters such as trash and the like, and the dispersion was stored.

Preparation of Reducing Agent-2 Dispersion

10 kg of water was added to 10 kg of the reducing agent-1 (6,6′-di-t-butyl-4,4′-dimethyl-2,2′-butylidenediphenol) and 16 kg of a 10% by weight aqueous solution of denatured polyvinyl alcohol (trade name: Povar MP203, manufactured by Kuraray Co. Ltd.), and mixed well to obtain a slurry. This slurry was fed with a diaphragm pomp, dispersed for 3 hours and 30 minutes with a transverse type sand mill (trade name: UVM-2, manufactured by AIMEX) charged with zirconia beads having an average diameter of 0.5 mm, and 0.2 g of a sodium salt of benzoisothiazolinone and water were added to adjust the concentration of a reducing agent to 25% by weight. This dispersion was heated at 40° C. for 1 hour, and subsequently heat-treated at 80° C. for 1 hour to obtain a reducing agent-2 dispersion. A reducing agent particle contained in the thus obtained reducing agent dispersion had a median diameter of 0.50 μm and a maximum particle diameter of 1.6 μm or smaller. The resulting reducing agent dispersion was filtered with a polypropylene filter having a pore diameter of 3.0 μm to remove foreign matter such as a trash and the like, followed by storing.

Preparation of Hydrogen Bond-Forming Compound-1 Dispersion

10 kg of water was added to 10 kg of the hydrogen bond-forming compound-1 (tri(4-t-butylphenyl)phosphine oxide) and 16 kg of a 10% by weight aqueous solution of denatured polyvinyl alcohol (trade name: Povar MP 203, manufactured by Kuraray Co., Ltd.), and mixed well to obtain a slurry. This slurry was fed with a diaphragm pump, dispersed for 4 hours with a transverse-type sand mill (trade name: UVM-2, manufactured by AIMEX) charged with zirconia beads having an average diameter of 0.5 mm, and 0.2 g of a sodium salt of benzoisothiazolinone and water were added to adjust the concentration of the hydrogen bond-forming compound to 25% by weight. This dispersion was heated at 40° C. for 1 hour, and subsequently warmed at 80° C. for 1 hour to obtain the hydrogen bond-forming compound-1 dispersion. A hydrogen bond-forming compound particle contained in the thus obtained hydrogen bond-forming compound dispersion had a median diameter of 0.45 μm and a maximum particle diameter of 1.3 μm. The resulting hydrogen bond-forming compound dispersion was filtered with a polypropylene filter having a pore diameter of 3.0 μm, to remove foreign matters such as a trash, followed by storing.

Preparation of Development Promoter-1 Dispersion

10 kg of water was added to 10 kg of the development promoter-1 and 20 kg of 10% by weight aqueous solution of denatured polyvinyl alcohol (trade name: Povar MP 203, manufactured by Kuraray Co., Ltd.), and mixed well to obtain a slurry. This slurry was fed with a diaphragm pump, dispersed for 3 hours and 30 minutes with a transverse-type sand mill (trade name: UVM-2, manufactured by AIMEX) charged with zirconia beads having an average diameter of 0.5 mm, and 0.2 g of a sodium salt of benzoisothiazolinone and water were added so that the concentration of development promoter became 20% by weight, to obtain a development promoter 1 dispersion. A development promoter particle contained in the thus obtained development promoter dispersion had a median diameter of 0.48 μm and a maximum particle diameter of 1.4 μm. The resulting development promoter dispersion was filtered with a polypropylene filter having a pore diameter of 3.0 μm, to remove foreign matters such as a trash and the like, followed by storing.

Preparation of Solid Dispersions of Development Promoter-2 and Tone Adjusting Agent-1

Regarding solid dispersions of the development promoter-2 and the tone adjusting agent-1, according to the same manner as that of the development promoter-1, the materials were dispersed as in the developing-1, to obtain 20% by weight dispersion and 15% by weight dispersions, respectively.

Preparation of Polyhalogen Compound

Preparation of Organic Polyhalogen Compound-1 Dispersion

10 kg of an organic polyhalogen compound-1 (tribromomethanesulfonylbenzene), 10 kg of a 20% by weight aqueous solution of denatured polyvinyl alcohol (trade name: Povar MP 203, manufactured by Kurarey Co., Ltd.), 0.4 kg of a 20% by weight aqueous solution of sodium triisopropylnaphthalenesulfonate and 14 kg of water were added, and mixed well to obtain a slurry. This slurry was fed with a diaphragm pump, dispersed for 5 hours with a transverse-type sand mill (trade name: UVM-2, manufactured by AIMEX) charged with zirconia beads having an average diameter of 0.5 mm, and 0.2 g of a sodium salt of benzoisothiazolinone and water were added so that the concentration of the organic polyhalogen compound became 26% by weight, to obtain an organic polyhalogen compound-1 dispersion. An polyhalogen compound particle contained in the thus obtained polyhalogen compound had a median diameter of 0.41 μm and a maximum particle diameter of 2.0 μm. The resulting organic polyhalogen compound dispersion was filtered with a polypropylene filter having a pore diameter of 10.0 μm, to remove foreign matters such as a trash and the like, followed by storing.

Preparation of Organic Polyhalogen Compound-2 Dispersion

10 kg of an organic polyhalogen compound-2 (N-butyl-3-tribromomethanesulfonylbenzamide), 20 kg of a 10% by weight aqueous solution of denatured polyvinyl alcohol (trade name: Povar MP 203, manufactured by Kurarey Co., Ltd.), and 0.4 kg of a 20% by weight aqueous solution of sodium triisopropylnaphthalenesulfonate were added, and mixed well to obtain a slurry. This slurry was fed with a diaphragm pump, dispersed for 5 hours with a transverse-type sand mill (trade name: UVM-2, manufactured by AIMEX) charged with zirconia beads having an average diameter of 0.5 mm, and 0.2 g of a sodium salt of benzoisothiazolinone and water were added to adjust the concentration of the organic polyhalogen compound to 30% by weight. This dispersion was warmed at 40° C. for 5 hours to obtain an organic polyhalogen compound-2 dispersion. An organic polyhalogen compound particle contained in the thus obtained polyhalogen compound dispersion had a median diameter of 0.40 μm and a maximum particle diameter of 1.3 μm or smaller. The resulting organic polyhalogen compound dispersion was filtered with a polypropylene filter having a pore diameter of 3.0 μm, to remove foreign matters such as a trash and the like, followed by storing.

Preparation of Phthalazine Compound-1 Solution

8 kg of denatured polyvinyl alcohol (trade name: MP 203, manufactured by Kurarey Co., Ltd.) was dissolved in 174.57 kg of water, and 3.15 kg of a 20% by weight aqueous solution of sodium triisopropylnaphthalenesulfonate and 14.28 kg of a 70% by weight solution of a phthalazine compound-1 (6-isopropylphthalazine) were added to prepare a 5% by weight solution of the phthalazine compound-1.

Preparation of Mercapto Compound

Preparation of Aqueous Mercapto Compound-1 Solution

7 g of a mercapto compound-1 (sodium salt of 1-(3-sulfophenyl)-5-mercaptotetrazole) was dissolved in 993 g of water to obtain a 0.7% by weight aqueous solution.

Preparation of Aqueous Mercapto Compound-2 Solution

20 g of a mercapto compound-2 (sodium salt of 1-(3-methylureido)-5-mercaptotetrazole) was dissolved in 980 g of water to obtain a 2.0% by weight aqueous solution.

Preparation of Pigment-1 Dispersion

64 g of C. I. Pigment Blue 60 and 6.4 g of a surfactant (trade name: Demol N, manufactured by Kao Corporation) were added to 250 g of water, and mixed well to obtain a slurry. 800 g of zirconia beads having an average diameter of 0.5 mm were prepared, placed into a vessel together with the slurry, dispersed for 25 hours with a dispersing machine (trade name: 1/4 G sand grinder mill, manufactured by AIMEX), and water was added to adjust the concentration of the pigment to 5% by weight to obtain a pigment dispersion. A pigment particle contained in the thus obtained pigment dispersion had an average particle diameter of 0.21 μm.

Preparation of SBR Latex

SBR latex is prepared as follows:

287 g of distilled water, 7.73 g of a surfactant (trade name: Pionin A-43-S, manufactured by Takemoto Oil & Fat Co., Ltd.: solid 48.5%), 14.06 ml of 1 mol/liter NaOH, 0.15 g of a tetrasodium salt of ethylenediaminetetraacetic acid, 255 g of styrene, 11.25 g of acrylic acid and 3.0 g of tert-dodecylMercapto were placed into a polymerization kettle of a gas monomer reaction apparatus (trade name: TAS-2J Type, manufactured by TAIATSU TECHNO CORPORATION), and the reaction vessel was sealed, followed by stirring at a stirring rate of 200 rpm. The vessel was degassed with a vacuum pump, nitrogen gas replacement was repeated several times, 108.75 g of 1,3-butadiene was pressed into the vessel, and an internal temperature was raised to 60° C. To this was added a solution in which 1.875 g of ammonium persulfate aws dissolved in 50 ml of water, and stirred as it was for 5 hours. A temperature was further raised to 90° C., the material was stirred for 3 hours and, after completion of the reaction, an internal temperature was lowered to room temperature, treatment was performed to Na⁺ ion:NH₄+ ion=1:5.3 (molar ratio) using 1 mol/liter of NaOH and NH₄OH, and a pH was adjusted to 8.4. Thereafter, filtration was performed with a polypropylene filter having a pore diameter of 1.0 μm to remove foreign matter such as a trash, and 774.7 g of SDR latex was obtained. A halogen ion was measured by ion chromatography, and the chloride ion concentration was found to be 3 ppm. The concentration of a chelating agent was measured by high speed liquid chromatography was measured, and it was found to be 145 ppm.

The aforementioned latex had an average particle diameter of 90 nm, Tg=17° C., the solid concentration of 44% by weight, the equilibrium moisture content at 25° C. and 60% RH of 0.6% by weight, and the ion conductivity of 4.80 mS/cm (the ion conductivity of the latex stock solution (44% by weight) was measured at 25° C. using a conductivity meter (trade name: CM-30S, manufactured by DKK-TOA Corporation)).

SBR latex having different Tg can be prepared by the similar method by appropriately changing a ratio of styrene and butadiene.

Preparation of Emulsion Layer (Photosensitive Layer) Coating Solution-1

1000 g of the above-obtained fatty acid silver dispersion A, 135 ml of water, 35 g of the pigment-1 dispersion, 19 g of the organic polyhalogen compound-1 dispersion, 58 g of the organic polyhalogen compound-2 dispersion, 162 g of the phthalazine compound-1, 1060 g of the SBR latex (Tg: 17° C.) solution, 75 g of the reducing agent-1 dispersion, 75 g of the reducing agent-2 dispersion, 106 g of the hydrogen bond-forming compound-1 dispersion, 4.8 g of the development promoter-1 dispersion, 9 ml of the aqueous mercapto compound-1 solution, and 27 ml of the aqueous mercapto compound-2 solution were successively added and, immediately before coating, 118 g of the silver halide-mixed emulsion A was added, the materials were mixed well to obtain an emulsion layer coating solution, which was supplied as it is to a coating die, followed by coating.

A viscosity of the above-mentioned emulsion layer coating solution was measured with a B-type viscometer of Tokyokeiki, and was found to be 25 [mPa·s] at 40° C. (No. 1 rotor, 60 rpm).

A viscosity of a coating solution at 38° C. as measured using RheoStress RS 150 (trade name, manufactured by Haake) was 32, 35, 33, 26 or 17 [mPa·s], respectively, at a shear rate of 0.1, 1, 10, 100 or 1000 [1/second].

An amount of zirconium in the coating solution was 0.32 mg per 1 g of silver.

Preparation of Emulsion Layer (Photosensitivity Layer) Coating Solution-2

1000 g of the above-obtained fatty acid silver dispersion, 135 ml of water, 36 g of the pigment-1 dispersion, 25 g of the organic polyhalogen compound-1 dispersion, 39 g of the organic polyhalogen compound-2 dispersion, 171 g of the phthalazine compound-1 solution, 1060 g of the SBR latex (Tg: 17° C.) solution, 153 g of the reducing agent-2 dispersion, 55 g of hydrogen bond-forming compound-1 dispersion, 4.8 g of the development promoter-1 dispersion, 5.2 g of the development promoter-2 dispersion, 2.1 g of the tone adjusting agent-1 dispersion, and 8 ml of the aqueous mercapto compound-2 solution were successively added and, immediately before coating, 140 g of a silver halide-mixed emulsion A was added, and the materials are mixed well to obtain an emulsion layer coating solution, which was supplied as it was to a coating die, followed by coating.

A viscosity of the above-mentioned emulsion layer coating solution was measured with a B-type viscometer provided by Tokyokeiki. Co. Ltd., and found to be 40 [mPa·s] at 40° C. (No. 1 rotor, 60 rpm).

A viscosity of a coating solution at 38° C. as measured using RheoStress RS 150 manufactured by Haake was 30, 43, 41, 28 or 20 [mPa·s], respectively, at a shear rate of 0.1, 1, 10, 100 or 1000 [1/second].

An amount of zirconium in the coating solution was 0.30 mg per 1 g of silver.

Preparation of Emulsion Surface Immediate Layer Coating Solution

27 ml of a 5% by weight aqueous solution of Aerosol OT (trade name, manufactured by American Cyanamide), 135 ml of a 20% by weight aqueous solution of a diammonium salt of phthalic acid, and water are added to 1000 g of polyvinyl alcohol (trade name: PVA-205, manufactured by Kurarey Co., Ltd.), 163 g of the pigment-1 dispersion, 33 g of an aqueous blue dye compound-1 (trade name: Kayafectototarcoize RN liquid 150, manufactured by Nippon Kayaku Co., Ltd.) solution, 27 ml of a 5% aqueous solution of a sodium salt of di(2-ethylhexyl) sulfosuccinate, and 4200 ml of a 19% by weight solution of methyl methacrylate/styrene/butyl acrylate/hydroxyethyl methacrylate/acrylic acid copolymer (copolymerization ratio 57/8/28/5/2) latex, to a total amount of 10000 g, a pH was adjusted to 7.5 with NaOH to obtain an intermediate layer coating solution, which was supplied to a coating die at 8.9 ml/m².

A viscosity of a coating solution is 58 [mPa·s] as measured by B-type viscometer (No. 1 rotor, 60 rpm) at 40° C.

Preparation of Emulsion Surface Protecting Layer First Layer Coating Solution

100 g of inert gelatin and 10 mg of benzoisothiazolinone were dissolved in 840 ml of water, 100 g of a 19% by weight solution of methyl methacrylate/styrene/butyl acrylate/hydroxyethyl methacrylate/acrylic acid copolymer (copolymerization ratio 57/8/28/5/2) latex, 46 ml of a 15% by weight solution of phthalic acid in methanol, and 5.4 ml of a 5% by weight aqueous solution of a sodium salt of di(2-ethylhexyl)sulfosuccinate were added to mix and, immediately before coating, 40 ml of 4% by weight chromium alum was mixed therein with a static mixer, which was supplied to a coating die at a coating solution amount of 26.1 ml/m².

A viscosity of a coating solution was 20 [mPa·s] as measured by a B-type viscometer (No. 1 rotor, 60 rpm) at 40° C.

Preparation of Emulsion Surface Protecting Layer Second Layer Coating Solution

100 g of inert gelatin and 10 mg of benzoisothiazolinone were dissolved in 800 ml of water, and 180 g of a 19% by weight solution of methyl methacrylate/styrene/butyl acrylate/hydroxyethyl methacrylate/acrylic acid copolymer (copolymerization ratio 57/8/28/5/2) latex, 40 ml of a 15% by weight solution of phthalic acid in methanol, 5.5 ml of a 1% by weight solution of a fluorine type surfactant (F-1), 5.5 ml of a 1% by weight aqueous solution of a fluorine type surfactant (F-2), 28 ml of a 5% by weight aqueous solution of a sodium salt of di(2-ethylhexyl)sulfosuccinate, 4 g of a polymethyl methacrylate fine particle (average particle diameter 0.7 μm) and 21 g of a polymethyl methacrylate fine particle (average particle diameter 4.5 μm) were mixed therein to obtain a surface protecting layer coating solution, which was supplied to a coating die at 8.3 ml/m².

A viscosity of the coating solution was 19 [mPa·s] as measured by a B-type viscometer (No. 1 rotor, 60 rpm) at 40° C.

Preparation of Photothermographic Material-1

Simultaneous overlaying coating was performed so that an anti-halation layer coating solution was coated on a back surface side of the aforementioned undercoated support at a gelatin coating amount of 0.52 g/m², and the back surface protecting layer coating solution was coated thereon at a gelatin coating amount of 1.7 g/m², and dried to prepare a back layer.

Simultaneous overlaying coating was performed on a surface opposite to the back surface in an order of an emulsion layer, an intermediate layer, a protecting layer first layer and a protecting layer second layer from the undercoated surface in a slide bead coating manner, to prepare a sample of a photothermographic material. Thereupon, the emulsion layer and the intermediate layer were adjusted at 31° C., the protecting layer first layer was adjusted at 36° C., and the protecting layer second layer was adjusted at 37° C.

A coating amount (g/m²) of each compound in the emulsion layer was as follows:

| | |
|---|---|
| Silver behenate | 5.42 |
| Pigment (C.I. Pigment Blue 60) | 0.036 |
| Polyhalogen compound-1 | 0.12 |
| Polyhalogen compound-2 | 0.25 |
| Phthalazine compound-1 | 0.18 |
| SBR-latex | 9.70 |
| Reducing agent-1 | 0.40 |
| Reducing agent-2 | 0.40 |
| hydrogen bond-forming compound-1 | 0.58 |
| Development promoter-1 | 0.02 |
| Mercapto compound-1 | 0.002 |
| Mercapto compound-2 | 0.012 |
| Silver halide (as Ag) | 0.10 |

The coating drying conditions were as follows:

Coating was performed at a speed of 160 m/min, a gap between a tip of a coating die and a support was 0.10 to 0.30 mm, and a pressure in an evacuating chamber was set low by 196 to 882 Pa relative to the atmospheric pressure. The support was subjected to eliminate of electricity with an ionic wind before coating.

Subsequently, in a chilling zone, the coating solution was cooled with a wind at a dry-bulb temperature of 10 to 20° C., conveyed in contactless manner, and dried with a dry wind at a dry-bulb temperature of 23 to 45° C. and a wet-bulb temperature of 15 to 21° C. using a helical contactless drying apparatus.

After drying and humidity conditioning at 25° C. and humidity of 40 to 60% RH, a film surface was heated to 70 to 90° C. After heating, a film surface was cooled to 25° C.

A matting degree of the prepared photothermographic material as Beck smoothness was 550 seconds in the photosensitive layer side and 130 seconds in the back side. In addition, a pH of a film surface on the photosensitive surface side was measured and found to be 6.0.

Preparation of Photothermographic Material-2

According to the same manner as that of the photothermographic material-1 except that the emulsion layer coating solution-1 was changed to the emulsion layer coating solution-2 in the photothermographic material-1, a photothermographic material-2 was prepared.

Upon this, a coating amount (g/m²) of each compound of the emulsion layer was as follows:

| | |
|---|---|
| Silver behenate | 5.27 |
| Pigment (C.I. Pigment Blue 60) | 0.036 |
| Polyhalogen Compound-1 | 0.14 |
| Polyhalogen Compound-2 | 0.28 |
| Phthalazine Compound-1 | 0.18 |
| SBR latex | 9.43 |
| Reducing Agent-2 | 0.77 |
| Hydrogen bond-forming compound-1 | 0.28 |
| Development promoter-1 | 0.019 |
| Development promoter-2 | 0.016 |
| Tone adjusting agent-1 | 0.006 |
| Mercapto Compound-2 | 0.003 |
| Silver halide (as Ag) | 0.13 |

Chemical structures of compounds used in Examples of the invention will be shown below. 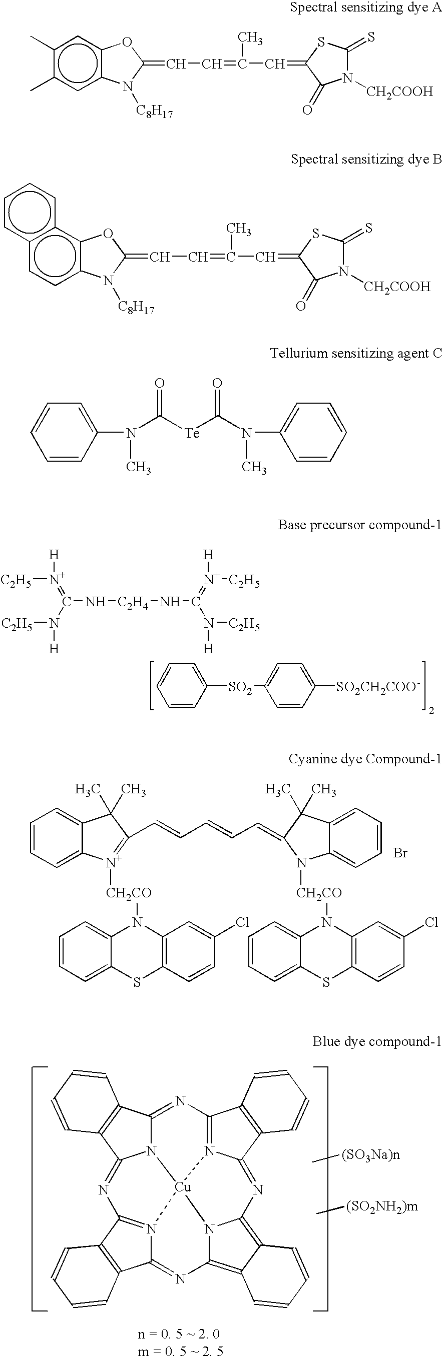 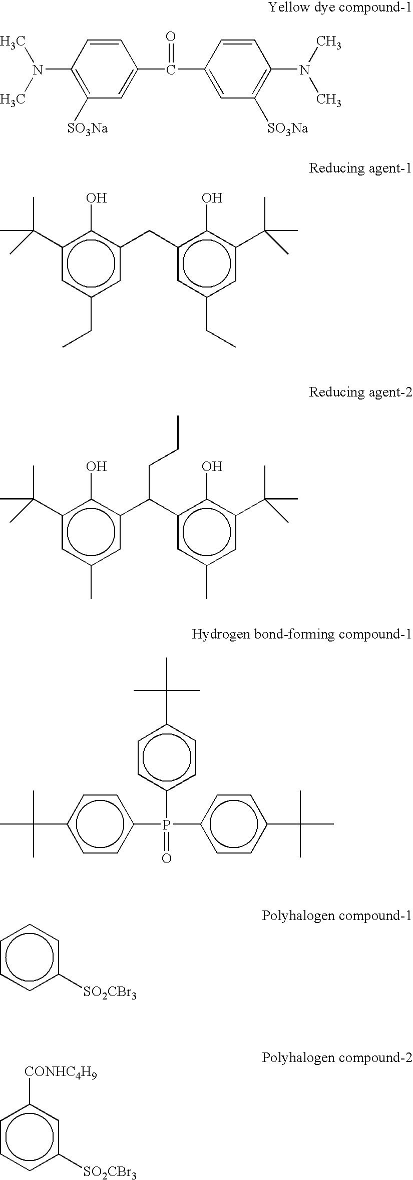 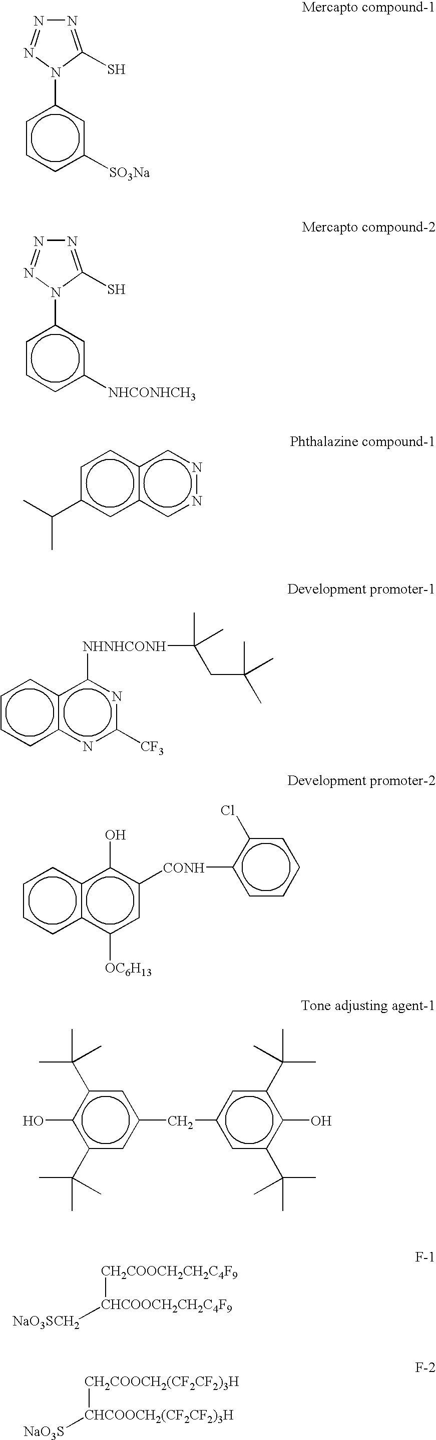
Evaluation of Photographic Property

The resulting sample was cut into a half cut size, packaged into the following packaging material under the environment at 25° C. and 50%, stored under a normal temperature for 2 hours, and subjected to the following evaluation.

Packaging Material

PET 10μ/PE 12μ/aluminium foil 9μ/Ny 15μ/polyethylene containing 3% carbon 50μ
Oxygen permeability: 0.02 ml/atm·m²·25° C.·day, Moisture permeability: 0.10 g/atm·m²·25° C.·day

The sample was exposed and thermally developed with Fuji Medical dry laser imager FM-DP L (trade name) (equipped with 660 nm semiconductor laser having 60 mW (IIIB) output at maximum) (Using four panel heaters set at 112° C.-119° C.-121° C.-121° C., the photothermographic material-1 was treated for a total of 24 seconds, and the photothermographic material 2 was treated for a total of 14 seconds), and evaluation of the resulting image was performed with a densitometer.

The above-prepared two kinds of photothermographic materials were subjected to thermal developing treatment by the above-described method, and it was confirmed that a thermal developing treating machine worked stable by comparing with management data, and the following experiment was performed.

### Example 1

Samples 001 to 020 was prepared by removing the reducing agent-1 and the reducing agent-2 and, instead, using a comparative reducing agent, a reducing agent of the general formula (R1) in the invention and a reducing agent of the general Formula (R2) in the invention shown in Table 1, in the aforementioned photothermographic material-1. Amounts of reducing agents which were used instead were shown in Table 1 as a relative ratio relative to a total mole number of the reducing agent-1 and the reducing agent-2. That was, 100% meant that the same mole number as a total mole number of the reducing agent-1 and the reducing agent-2 was added, and 7-0% meant that a mole number corresponding to 70% of the total mole number was added.
Comparative Reducing Agent

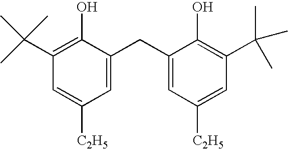

An image-exposure was given to these samples using Fuji Medical dry laser imager FM-DP L (trade name), and thermal developing treatment was performed under the standard conditions at four thermal developing plates temperatures of 112° C.-119° C.-121° C.-121° C. every 6 seconds for a total of 24 seconds. The relative sensitivity ΔS1.5 was obtained from a logarithmic value of an exposure amount giving the concentration of 1.5.

Then, image output of a CR photograph of lung and a MR tomogram was performed, to prepare a practical skill image treated under the standard developing conditions, and the practical skill image was evaluated with naked eyes by Schaukasten. Evaluation was conducted by 10 observers and, when 9 or more observers judged as a preferable color, it was scored as ⊚, when 7 to 8 observers judged as a preferable color, it was scored as ◯, when 4 to 6 observers judged as a preferable color, it was scored as Δ and, when 3 or less observers judged as a preferable color, it was scored as X. In the case of evaluation of Δ or worse, in what a direction a tone was shifted was determined.

Further, under the standard conditions, thermal developing treatment was performed similarly (1) when a temperature of each plate was changed at ±2° C., (2) when a total of a developing time was changed by ±2 seconds, (3) when a temperature of each plate was changed by +1° C. and a total of a developing time was changed by +1 seconds, (4) when a temperature of each plate was changed by −1° C. and a total of a developing time was changed by −1 second, (5) when a temperature of each plate was changed by +2° C. and a total of a developing time was changed by −2 seconds, and (6) when a temperature of each plate was changed by −2° C. and a total of a developing time was changed by +2 seconds. A developing time was changed so that a time of each plate was equally changed by changing a conveying speed. In each sample, a* and b* values were measured at points having the concentration of 1.5, and plotted on an a*b* ordinate. Among them, regarding two points which were most apart from each other, a distance therebetween r={root of ((Δa*)²+(Δb*)²)} was calculated and, based on this value, the stability of tone was evaluated. Δa* and Δb* represent a difference in a* values and b* values of two points which were most apart from each other, respectively. As the r value was smaller, a tone difference under the developing conditions was smaller, being preferable. The a* value and the b* value were calculated relative to the FLF5 light source based on CIE1976 standard.

The evaluation results were shown by four stages such that the R value of less than 0.5 is ⊚, not less than 0.5 and less than 1.0 was ◯, not less than 1.0 and less than 2.0 was Δ, and not less than 2.0 is X. The results were well consistent with results of organoleptic test with naked eyes.

TABLE 1

| | Reducing agent of | | Reducing agent of | | | | | | |
|---|---|---|---|---|---|---|---|---|---|
| | general formula R1 | | general formula R2 | | Relative | Tone | Tone stability | | |
| Sample | | Coating | | Coating | sensitivity | Standard | Maximum | Organoleptic | |
| No. | Species | amount | Species | amount | ΔS | development | distance (R) | evaluation | Remark |
| 001 | Comparative | 100% | — | — | ±0 | Δ (Purple) | Δ | Δ | Comparative |
| | reducing agent | | | | | | | | |
| 002 | R1-1 | 100% | — | — | −0.06 | X (Purple) | Unable to | Unable to | Comparative |
| | | | | | | | Evaluate | Evaluate | |
| 003 | R1-3 | 100% | — | — | −0.08 | X (Purple) | Unable to | Unable to | Comparative |
| | | | | | | | Evaluate | Evaluate | |
| 004 | — | — | R2-1 | 100% | +0.10 | X (Yellow) | Unable to | Unable to | Comparative |
| | | | | | | | Evaluate | Evaluate | |
| 005 | — | — | R2-4 | 100% | −0.02 | ◯ | X | X | Comparative |
| 006 | Comparative | 90% | R2-1 | 10% | +0.06 | Δ (Yellow) | Δ | Δ | Comparative |
| | reducing agent | | | | | | | | |
| 007 | Comparative | 70% | R2-4 | 30% | −0.01 | Δ (Yellow) | Δ | Δ | Comparative |
| | reducing agent | | | | | | | | |
| 008 | R1-1 | 90% | R2-1 | 10% | +0.01 | ⊚ | ⊚ | ⊚ | The Invention |
| 009 | R1-1 | 70% | R2-2 | 30% | −0.04 | ◯ | ◯ | ⊚ | The Invention |
| 009* | R1-1 | 70% | R2-2 | 30% | +0.01 | ⊚ | ◯ | ⊚ | The Invention |
| 010 | R1-1 | 60% | R2-2 | 40% | −0.03 | ◯ | ⊚ | ⊚ | The Invention |
| 011 | R1-1 | 50% | R2-2 | 50% | −0.02 | Δ (Yellow) | ◯ | ◯ | The Invention |
| 012 | R1-1 | 70% | R2-4 | 30% | −0.03 | ◯ | ◯ | ⊚ | The Invention |
| 013 | R1-1 | 70% | R2-9 | 30% | +0.01 | ◯ | ◯ | ◯ | The Invention |
| 014 | R1-1 | 80% | R2-13 | 20% | +0.02 | ◯ | ◯ | ◯ | The Invention |
| 015 | R1-3 | 90% | R2-1 | 10% | +0.00 | ⊚ | ⊚ | ⊚ | The Invention |
| 016 | R1-3 | 70% | R2-4 | 30% | −0.01 | ◯ | ◯ | ⊚ | The Invention |
| 017 | R1-3 | 80% | R2-8 | 20% | +0.02 | ◯ | ◯ | ◯ | The Invention |
| 018 | R1-6 | 70% | R2-3 | 30% | −0.03 | ◯ | ◯ | ◯ | The Invention |
| 019 | R1-13 | 70% | R2-3 | 30% | −0.06 | ◯ | ◯ | ◯ | The Invention |
| 020 | R1-15 | 70% | R2-3 | 30% | −0.04 | ◯ | ◯ | ◯ | The Invention |

Note)
009* means that an amount of a development promoter-1 is increased by 20% relative to 009.

From Table 1, it can be seen that samples 008 to 020 which were combinations of the invention were excellent photothermographic materials which were excellent in tone at standard development and, at the same time, were small in variation of tone under the developing conditions.

### Example 2

Samples 101 to 120 were prepared by removing the reducing agent-2 and, instead, using a comparative reducing agent, a reducing agent of the general formula (R1) in the invention and a reducing agent of the general formula (R2) in the invention, in the photothermographic material-2. Addition amounts were described in Table 2 as a ratio relative to an amount of the reducing agent-2 to be added.

Also in these samples, evaluation was performed as in Example 1. As a laser imager, test machines of the apparatus described in Japanese Patent Application Nos. 2002-88832 and 2002-9114 were used. As an exposing part, a 50 mW semiconductor laser (660 nm) was used and, as a thermal source part, a plate-type heater controlled at 107° C.-121° C.-121° C. was used. A thermal developing time was a total of 14 seconds as a sum of each 4.7 seconds.

The resulting results were shown in Table 2.

TABLE 2

| | Reducing agent of | | Reducing agent of | | | | | | |
|---|---|---|---|---|---|---|---|---|---|
| | general formula R1 | | general formula R2 | | Relative | Tone | Tone stability | | |
| Sample | | Coating | | Coating | sensitivity | Standard | Maximum | Organoleptic | |
| No. | Species | amount | Species | amount | ΔS | development | distance (R) | evaluation | Remark |
| 101 | Comparative | 100% | — | — | ±0 | Δ (Purple) | Δ | Δ | Comparative |
| | reducing | | | | | | | | |
| | agent | | | | | | | | |
| 102 | R1-1 | 100% | — | — | −0.05 | X (Purple) | Unable to | Unable to | Comparative |
| | | | | | | | Evaluate | Evaluate | |
| 103 | R1-3 | 100% | — | — | −0.07 | X (Purple) | Unable to | Unable to | Comparative |
| | | | | | | | Evaluate | Evaluate | |
| 104 | — | — | R2-1 | 100% | +0.08 | X (Yellow) | Unable to | Unable to | Comparative |
| | | | | | | | Evaluate | Evaluate | |
| 105 | — | — | R2-4 | 100% | −0.01 | ◯ | X | X | Comparative |
| 106 | Comparative | 85% | R2-1 | 15% | +0.05 | Δ (Yellow) | Δ | Δ | Comparative |
| | reducing | | | | | | | | |
| | agent | | | | | | | | |
| 107 | Comparative | 60% | R2-4 | 40% | −0.01 | Δ (Yellow) | Δ | Δ | Comparative |
| | reducing | | | | | | | | |
| | agent | | | | | | | | |
| 108 | R1-1 | 90% | R2-1 | 10% | +0.01 | ◯ | ◯ | ⊚ | The Invention |
| 109 | R1-1 | 85% | R2-1 | 15% | +0.03 | ◯ | ⊚ | ⊚ | The Invention |
| 110 | R1-1 | 80% | R2-1 | 20% | +0.05 | ⊚ | ◯ | ⊚ | The Invention |
| 111 | R1-1 | 60% | R2-2 | 40% | −0.03 | ◯ | ◯ | ◯ | The Invention |
| 112 | R1-1 | 60% | R2-4 | 40% | −0.02 | ◯ | ◯ | ⊚ | The Invention |
| 112* | R1-1 | 60% | R2-4 | 40% | +0.02 | ⊚ | ◯ | ⊚ | The Invention |
| 113 | R1-1 | 80% | R2-18 | 20% | −0.01 | ◯ | ◯ | ◯ | The Invention |
| 114 | R1-1 | 70% | R2-18 | 30% | +0.01 | ◯ | ◯ | ◯ | The Invention |
| 115 | R1-3 | 85% | R2-1 | 15% | +0.02 | ⊚ | ⊚ | ⊚ | The Invention |
| 116 | R1-3 | 70% | R2-4 | 30% | −0.03 | ◯ | ◯ | ⊚ | The Invention |
| 117 | R1-3 | 80% | R2-18 | 20% | −0.02 | ◯ | ◯ | ◯ | The Invention |
| 118 | R1-7 | 70% | R2-3 | 30% | −0.03 | ◯ | ◯ | ◯ | The Invention |
| 119 | R1-14 | 70% | R2-3 | 30% | −0.05 | ◯ | ◯ | ◯ | The Invention |
| 120 | R1-16 | 70% | R2-3 | 30% | −0.03 | ◯ | ◯ | ◯ | The Invention |

Note)
112* means that an amount of a development promoter-1 and that of a development promoter-2 are increased by 10% relative to 112.

From Table 2, it can be seen that samples 108 to 120 which were combinations of the invention are excellent photothermographic materials which were excellent in tone at standard development and, at the same time, were small in variation of tone under the developing conditions.

From the above results, it can be seen that, by a combination of reducing agents in the invention, finished tone can be controlled at preferable tone and, additionally, variation of image tone under the developing conditions can be remarkably reduced.

According to the invention, a photothermographic material having the stable performance by which a constant tone is usually obtained is obtained even when a thermal developing temperature and a thermal developing time vary.

What is claimed is:

1. A photothermographic material comprising a substrate, and a photosensitive silver halide, a non-photosensitive organic silver salt, reducing agents for thermal development and a binder which are provided on the substrate, wherein:
the reducing agents for thermal development include a reducing agent which does not form a dye during thermal development and a reducing agent which forms a dye during thermal development; and
the reducing agent which forms a dye has higher activity than that of the reducing agent which does not form a dye.

2. A photothermographic material according to claim 1, wherein the reducing agent which does not form a dye is a compound represented by the general formula (R1), and the reducing agent which forms a dye is a compound represented by the following general formula (R2): 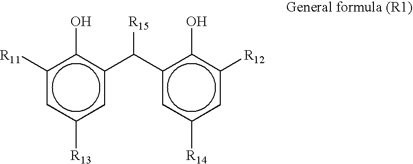
wherein R₁₁ and R₁₂ each independently represent a secondary or tertiary alkyl group; R₁₃ and R₁₄ each independently represent an alkyl group having a 2 or more carbon atoms; and R₁₅ represents an alkyl group: 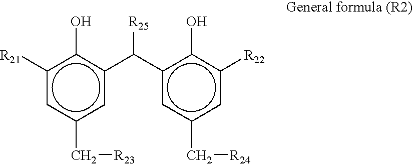
wherein R₂₁ and R₂₂ each independently represent a secondary or tertiary alkyl group; R₂₃ and R₂₄ each independently represent a hydrogen atom, a hydroxyl group, an alkoxy group, an aryloxy group, an acyloxy group, an amino group or a heterocyclic group; and R₂₅ represents a hydrogen atom or an alkyl group.

3. A photothermographic material according to claim 1, wherein the reducing agent represented by general formula (R2) is contained in an amount of 40% by mol or less relative to a total amount of the reducing agents.

4. A photothermographic material according to claim 2, wherein the reducing agent represented by general formula (R2) is contained in an amount of 40% by mol or less relative to a total amount of the reducing agents.

5. A photothermographic material according to claim 1, which further comprises a development promoter.

6. A photothermographic material according to claim 2, which further comprises a development promoter.

7. A photothermographic material according to claim 5, wherein the development promoter contains at least one selected from the group consisting of a compound represented by the following general formulae (A-1) and a compound represented by the following general formula (A-2):
Q₁-NHNH-Q₂ General formula (A-1)
wherein Q₁ represents an aromatic group or a heterocyclic group which bonds to —NHNH-Q₂ via a carbon atom; Q₂ represents a carbamoyl group, an acyl group, an alkoxycarbonyl group, an aryloxycarbonyl group, a sulfonyl group or a sulfamoyl group, 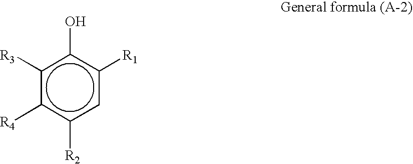
wherein R₁ represents an alkyl group, an acyl group, an acylamino group, an sulfonamide group, an alkoxycarbonyl group, or a carbamoyl group; R₂ represents a hydrogen atom, a halogen atom, an alkyl group, an alkoxy group, an aryloxy group, an alkylthio group, an arylthio group, an acyloxy group, or a carbonic acid ester group; and R₃ and R₄ each represent a group which is substitutable at a benzene ring, or couple with each other to form a condensed ring.

8. A photothermographic material according to claim 6, wherein the development promoter contains at least one selected from the group consisting of a compound represented by the following general formulae (A-1) and a compound represented by the following general formula (A-2):
Q₁-NHNH-Q₂ General formula (A-1)
wherein Q₁ represents an aromatic group or a heterocyclic group which bonds to —NHNH-Q₂ via a carbon atom; Q₂ represents a carbamoyl group, an acyl group, an alkoxycarbonyl group, an aryloxycarbonyl group, a sulfonyl group or a sulfamoyl group, 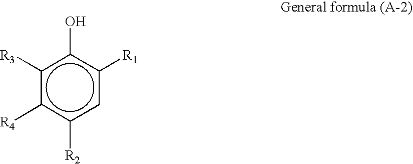
wherein R₁ represents an alkyl group, an acyl group, an acylamino group, an sulfonamide group, an alkoxycarbonyl group, or a carbamoyl group; R₂ represents a hydrogen atom, a halogen atom, an alkyl group, an alkoxy group, an aryloxy group, an alkylthio group, an arylthio group, an acyloxy group, or a carbonic acid ester group; and R₃ and R₄ each represent a group which is substitutable at a benzene ring, or couple with each other to form a condensed ring.

9. A photothermographic material according to claim 1, which further comprises a hydrogen bond-forming compound.

10. A photothermographic material according to claim 2, which further comprises a hydrogen bond-forming compound.

11. A photothermographic material according to claim 7, which further comprises a hydrogen bond-forming compound.

12. A photothermographic material according to claim 8, which further comprises a hydrogen bond-forming compound.

13. A photothermographic material according to claim 9, wherein the hydrogen bond-forming compound is a compound represented by the following general formula (D): 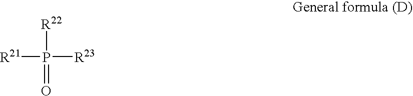
wherein R²¹ to R²³ each independently represent an alkyl group, an aryl group, an alkoxy group, an aryloxy group, an amino group or a heterocyclic group.

14. A photothermographic material according to claim 1, which comprises a compound represented by the following general formula (H);
Q-(Y)ₙ—C(Z₁)(Z₂)X General formula (H)
wherein Q represents an alkyl group, an aryl group or a heterocyclic group; Y represents a divalent linking group; Z₁ and Z₂ each represent a halogen atom; X represents a hydrogen atom or an electron withdrawing group; and n represents 0 or 1.

15. A photothermographic material according to claim 1, wherein a total amount of coated silver is 1.9 g/m² or less.

16. A photothermographic material according to claim 1, wherein thermal developing is completed within 16 seconds.
